(19) United States
(12) Patent Application Publication
(10) Pub. No.: US 2016/0253088 A1
(43) Pub. Date: Sep. 1, 2016

(54) DISPLAY CONTROL APPARATUS AND DISPLAY CONTROL METHOD

(71) Applicant: MITSUBISHI ELECTRIC CORPORATION, Tokyo (JP)

(72) Inventors: Naoki ISOZAKI, Tokyo (JP); Mitsuo SHIMOTANI, Tokyo (JP); Naoki SHIMIZU, Tokyo (JP)

(73) Assignee: MITSUBISHI ELECTRIC CORPORATION, Tokyo (JP)

(21) Appl. No.: 15/031,626

(22) PCT Filed: Dec. 5, 2013
(86) PCT No.: PCT/JP2013/082685

§ 371 Date: Apr. 22, 2016

(51) Int. Cl. G06F 3/0488; G06F 3/0484; G06F 3/0481

(52) U.S. Cl. CPC G06F 3/04883; G06F 3/04812; G06F 3/04817; G06F 3/04842; G06F 2203/04101

(57) ABSTRACT

It is an object of the present invention to provide a technique for selectively performing a desired function. A PC controls a display which is capable of displaying an image. When it is determined that a first prescribed operation which is prescribed in advance has been performed, a controller decides the first prescribed operation which is determined to have been performed, as a first operation used to perform a function of a predetermined application. The controller causes the display to display thereon a display icon which is capable of guiding the first prescribed operation to be performed.

### TECHNICAL FIELD

The present invention relates to a display control apparatus and a display control method, which control a display.

### BACKGROUND ART

As a multiple image display device which is capable of displaying, on one screen, different images depending on the direction of viewing the screen, a split view (also referred to as multi view or dual view (registered trademark)) type display device is well known, and recently in various fields, it is proposed to apply a split view display device. It is proposed, for example, that a split view display device and a touch panel provided on a screen thereof are applied to an in-vehicle navigation apparatus. By using such a navigation apparatus, it becomes possible to display images of different contents viewed from a direction of the driver seat side and from another direction of the front passenger seat side on a screen and receive operations on respective icons displayed in the images from the touch panel.

In such a navigation apparatus as described above, however, there is a case where a position of an icon in an image displayed in the direction of the driver seat side and a position of an icon in another image displayed in the direction of the front passenger seat side overlap each other on the screen of the split view display device. In such a case, even if an operation on the icon is received from the touch panel, it cannot be decided, disadvantageously, whether the operation is performed on the icon in the image displayed in the direction of the driver seat side or on the icon in the image displayed in the direction of the front passenger seat side.

Then, in Patent Document 1, in order to prevent the position of the icon in the image displayed in the direction of the driver seat side and the position of the icon in the image displayed in the direction of the front passenger seat side from overlapping each other, proposed is a technique for arranging these icons at different positions.

### PRIOR-ART DOCUMENTS

### Patent Documents

[Patent Document 1] International Publication No. WO 2006/100904

### SUMMARY OF INVENTION

### Problems to be Solved by the Invention

However, in a case, for example, where a fellow passenger sitting on the front passenger seat performs an operation, such as a drag operation or the like, over a relatively wide range, or the like, there arises a problem that the fellow passenger unintentionally performs an operation on the icon in the image displayed in the direction of the driver seat side.

Then, the present invention is intended to solve the above problem, and it is an object of the present invention to provide a technique for selectively performing a desired function.

### Means for Solving the Problems

The present invention is intended for a display control apparatus that controls a display which is capable of displaying a first image. According to an aspect of the present invention, the display control apparatus includes a controller that decides a first prescribed operation which is determined to have been performed, as a first operation used to perform a function of a predetermined application, when it is determined that the first prescribed operation which is prescribed in advance has been performed, on the basis of an output signal from an input unit that receives an external operation. The controller causes the display to display thereon at least one of a first icon and a first display object in the first image, which is capable of guiding the first prescribed operation to be performed. The controller performs at least one of transformation of a second icon in the first image into the first icon and addition of the first display object to the first image when it is determined that a first action which is defined in advance as an action before performing the first prescribed operation has been performed or is being performed, on the basis of an output signal from the input unit, the first prescribed operation includes an operation drawing a predetermined orbit, which is performed on the first icon, and at least one of an outer frame shape of the first icon and a shape of an arrow included in the first display object corresponds to the orbit.

### Effects of the Invention

According to the aspect of the present invention, when it is determined that the first prescribed operation has been performed, the first prescribed operation is decided as the first operation. Therefore, a user can selectively perform a desired function. Further, the user can know what the first prescribed operation is like before performing the operation, with the display of at least one of the first icon and the first display object as a clue.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an exemplary constitution of a navigation apparatus in accordance with a first preferred embodiment;

FIG. 2 is a cross section showing an exemplary structure of a split view display in accordance with the first preferred embodiment;

FIG. 3 is a view showing an example of display of the split view display in accordance with the first preferred embodiment;

FIG. 4 is a cross section showing another exemplary structure of the split view display in accordance with the first preferred embodiment;

FIGS. 5A and 5B are views showing another example of display of the split view display in accordance with the first preferred embodiment;

FIG. 6 is a view showing an example of detection of an indicator by a touch panel;

FIG. 7 is a flowchart showing an operation of the navigation apparatus in accordance with the first preferred embodiment;

FIGS. 8A and 8B are views showing an example of display of a left image and a right image, respectively, in the navigation apparatus in accordance with the first preferred embodiment;

FIGS. 9A and 9B are views used for explaining the operation of the navigation apparatus in accordance with the first preferred embodiment;

FIGS. 10A and 10B are views also used for explaining the operation of the navigation apparatus in accordance with the first preferred embodiment;

FIGS. 11A and 11B are views showing an example of display of the left image and the right image, respectively, in the navigation apparatus in accordance with a first variation of the first preferred embodiment;

FIGS. 12A and 12B are views showing another example of display of the left image and the right image, respectively, in the navigation apparatus in accordance with the first variation of the first preferred embodiment;

FIGS. 13A and 13B are views showing still another example of display of the left image and the right image, respectively, in the navigation apparatus in accordance with the first variation of the first preferred embodiment;

FIGS. 14A and 14B are views showing yet another example of display of the left image and the right image, respectively, in the navigation apparatus in accordance with the first variation of the first preferred embodiment;

FIGS. 15A and 15B are views showing a further example of display of the left image and the right image, respectively, in the navigation apparatus in accordance with the first variation of the first preferred embodiment;

FIGS. 16A and 16B are views showing a still further example of display of the left image and the right image, respectively, in the navigation apparatus in accordance with the first variation of the first preferred embodiment;

FIGS. 17A and 17B are views showing a yet further example of display of the left image and the right image, respectively, in the navigation apparatus in accordance with the first variation of the first preferred embodiment;

FIGS. 18A and 18B are views showing a further example of display of the left image and the right image, respectively, in the navigation apparatus in accordance with the first variation of the first preferred embodiment;

FIGS. 19A and 19B are views used for explaining an operation of the navigation apparatus in accordance with a second variation of the first preferred embodiment;

FIGS. 20A and 20B are views also used for explaining the operation of the navigation apparatus in accordance with the second variation of the first preferred embodiment;

FIG. 21 is a flowchart showing an operation of the navigation apparatus in accordance with a second preferred embodiment;

FIGS. 22A and 22B are views showing an example of display of the left image and the right image, respectively, in the navigation apparatus in accordance with the second preferred embodiment;

FIGS. 23A and 23B are views showing another example of display of the left image and the right image, respectively, in the navigation apparatus in accordance with the second preferred embodiment;

FIG. 24 is a block diagram showing an exemplary constitution of a PC in accordance with a third preferred embodiment;

FIG. 25 is a flowchart showing an operation of the PC in accordance with the third preferred embodiment;

FIG. 26 is a view showing an example of display of an image on the PC in accordance with the third preferred embodiment;

FIG. 27 is a view showing another example of display of the image on the PC in accordance with the third preferred embodiment; and

FIG. 28 is a view showing an example of display of the image on the PC in accordance with a variation of the third preferred embodiment.

### DESCRIPTION OF EMBODIMENT(S)

### The First Preferred Embodiment

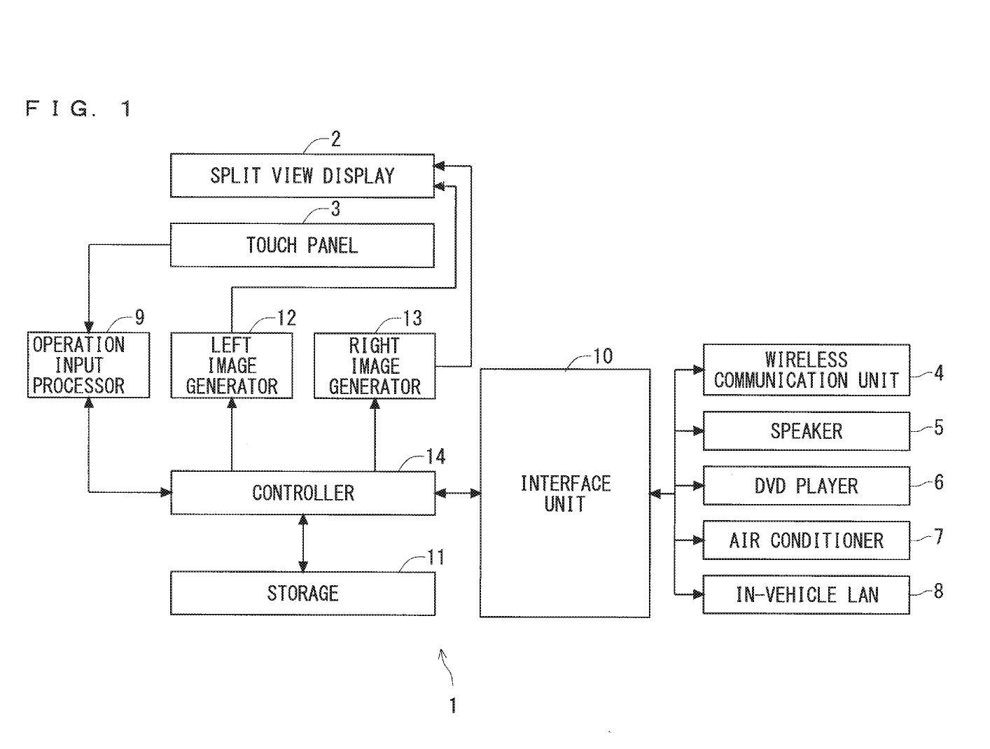

The first preferred embodiment of the present invention will be described, taking a case, as an example, where a display control apparatus in accordance with the present invention is applied to a navigation apparatus which can be mounted on a vehicle. FIG. 1 is a block diagram showing an exemplary constitution of the navigation apparatus. In the following description, a vehicle on which the navigation apparatus 1 shown in FIG. 1 is mounted is referred to as a “self-vehicle”.

The navigation apparatus 1 comprises a split view display 2, a touch panel 3, an operation input processor 9, an interface unit 10, a storage 11, a left image generator 12, a right image generator 13, and a controller 14 which generally controls these constituent elements.

The interface unit 10 is connected between the controller 14 and a wireless communication unit 4, a speaker 5, a DVD (Digital Versatile Disk) player 6, an air conditioner 7, and an in-vehicle LAN (Local Area Network) 8. Between the controller 14 and the wireless communication unit 4, the speaker 5, the DVD player 6, the air conditioner 7, and the in-vehicle LAN 8, various information and various signals are bidirectionally outputted through the interface unit 10. In the following description, for simplification, when it should be described that the element on one side outputs information to that on the other side through the interface unit 10, it will be described instead that the element on one side outputs information to that on the other side. The controller 14 outputs control information to the wireless communication unit 4, the speaker 5, the DVD player 6, the air conditioner 7, and the in-vehicle LAN 8, to thereby control these constituent elements.

The split view display 2 is provided on, for example, a dash board of the self-vehicle. The split view display 2 can display a first image (hereinafter, referred to as an “image for left” or a “left image”) which is visible from a direction of left seat (a first direction) but not visible from a direction of right seat and a second image (hereinafter, referred to as an “image for right” or a “right image”) which is visible from the direction of right seat (a second direction) but not visible from the direction of left seat, on one screen. Specifically, the split view display 2 can display the image which is visible from the direction of left seat but not visible from the direction of right seat, as the left image, and display the right image which is visible from the direction of right seat but not visible from the direction of left seat, on the same screen as the left image is displayed, by using the split view type.

As described later, the split view display 2 displays an icon (a first icon) in the left image and an icon (a second icon) in the right image. Hereinafter, the icon (the first icon) in the left image is referred to as an “icon for left” or a “left icon”, and the icon (the second icon) in the right image is referred to as an “icon for right” or a “right icon”. Further, though a case where the left seat is a driver seat and the right seat is a front passenger seat will be taken as an example in the following description, in another case where the left seat is the front passenger seat and the right seat is the driver seat, the “left” and the “right” in the following description are exchanged for each other.

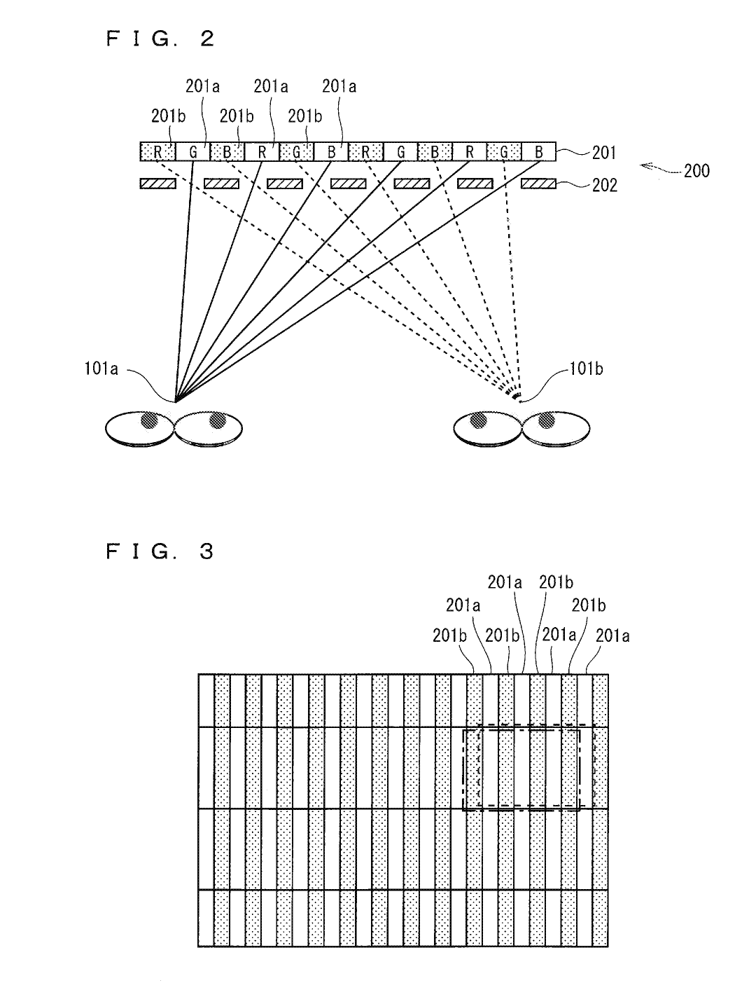

To the split view display 2, for example, applied is a space division display device. FIG. 2 is a schematic cross section of the display device. The display device 200 shown in FIG. 2 comprises a display screen 201 and a parallax barrier 202. In the display screen 201, first pixels 201a used for displaying the left image and second pixels 201b used for displaying the right image are arranged alternately along a horizontal direction (left-and-right direction). The parallax barrier 202 transmits light of the first pixel 201a but blocks light of the second pixel 201b with respect to the direction of left seat, and transmits light of the second pixel 201b but blocks light of the first pixel 201a with respect to the direction of right seat. By adopting this structure, a user 101a sitting on the left seat cannot see (visually recognize) the right image but can see the left image, and another user 101b sitting on the right seat cannot see the left image but can see the right image.

In the configuration where the space division display device 200 is applied to the split view display 2, the left icon is displayed visibly when the parallax barrier 202 transmits the light from a plurality of first pixels 201a in the direction of left seat, and the right icon is displayed visibly when the parallax barrier 202 transmits the light from a plurality of second pixels 201b in the direction of right seat. Therefore, an outer peripheral portion of a display area of the left icon corresponds to some of the plurality of first pixels 201a used to display the left icon, which are located at the outer peripheral portion, and an outer peripheral portion of a display area of the right icon corresponds to some of the plurality of second pixels 201b used to display the right icon, which are located at the outer peripheral portion.

FIG. 3 is a view showing an example of display of the space-division type split view display 2 and shows the left image and the right image in one frame. A WVGA (Wide VGA) display device, for example, has 800 dots in a transverse direction (x axis) and 480 dots in a longitudinal direction (y axis) in total. Though depending on the performance of the display device, the space-division type split view display device shown in FIG. 3 which corresponds to the WVGA display device, for example, has, in the transverse direction in total, as many as twice the number of pixels in the transverse direction in the WVGA display device, in other words, has 1600 dots of first pixels 201a and second pixels 201b in the transverse direction and 480 dots of first pixels 201a and second pixels 201b in the longitudinal direction in total. Herein, for simple illustration, however, description will be made assuming that the split view display device has 13 dots of first pixels 201a in the transverse direction and 4 dots of first pixels 201a in the longitudinal direction and also has the same number of second pixels 201b, and an icon is displayed with 4 dots of first pixels 201a or second pixels 201b in the transverse direction and one dot of first pixel 201a or second pixel 201b in the longitudinal direction. Further, one dot of deviation in the x-axis direction (left-and-right direction) in the icon as shown in FIG. 3 is not recognizable by human's eyes from a normal view position and can be seen as displayed at the same position.

In FIG. 3, the outer peripheral portion (outer frame) of the left icon is represented by a broken line, and this indicates that four first pixels 201a arranged in the horizontal direction are used to display the left icon. Further, in FIG. 3, the outer peripheral portion (outer frame) of the right icon is represented by a one-dot chain line, and this indicates that four second pixels 201b arranged in the horizontal direction are used to display the right icon. Furthermore, the number of first pixels 201a used to display the left icon and the number of second pixels 201b used to display the right icon are not each limited to four.

In the following description, in the configuration where the space division display device 200 is applied to the split view display 2, when at least one of the plurality of (in FIG. 3, four) first pixels 201a used to display the left icon is sandwiched by some (in FIG. 3, the second pixels 201b corresponding to the one-dot chain line) of the plurality of (in FIG. 3, four) second pixels 201b used to display the right icon, which are located at the outer peripheral portion, it will be described that at least part of the display area of the left icon and at least part of the display area of the right icon overlap each other on the screen of the split view display 2. Further, in this configuration, also when at least one of the plurality of (in FIG. 3, four) second pixels 201b used to display the right icon is sandwiched by some (in FIG. 3, the first pixels 201a corresponding to the broken line) of the plurality of (in FIG. 3, four) first pixels 201a used to display the left icon, which are located at the outer peripheral portion, it will be described that at least part of the display area of the left icon and at least part of the display area of the right icon overlap each other on the screen of the split view display 2. On the other hand, in this configuration, when either one of the second pixel 201b used to display the right icon and the first pixel 201a used to display the left icon is not sandwiched by the other pixels, it will be described that the display area of the left icon and the display area of the right icon are separate from each other on the screen of the split view display 2.

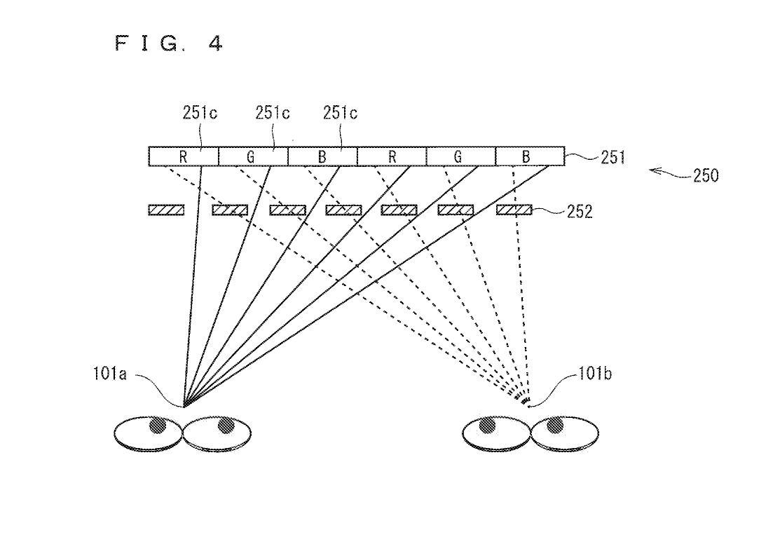

The above description has been made on the configuration where the space division display device 200 is applied to the split view display 2. This, however, is only one exemplary configuration. To the split view display 2, for example, a time division display device may be applied. FIG. 4 is a schematic cross section of the display device. The display device 250 shown in FIG. 4 comprises a display screen 251 and a parallax barrier 252. The display screen 251 displays the left image with pixels 251c in a first period and displays the right image with pixels 251c in a second period. The parallax barrier 252 transmits light of the pixel 251c with respect to the direction of left seat but blocks light of the pixel 251c with respect to the direction of right seat in the first period, and transmits light of the pixel 251c with respect to the direction of right seat but blocks light of the pixel 251c with respect to the direction of left seat in the second period. FIG. 4 shows the state in the first period.

By adopting the above-described structure, the left-seat user 101a cannot see the right image but can see the left image, and the right-seat user 101b cannot see the left image but can see the right image. Further, the eyes of the right-seat user 101b do not receive the light of the pixel 251c from the split view display 2 in the first period. Since the first period, however, is set very short, the right-seat user 101b cannot recognize that his eyes do not receive the light in the first period. On the other hand, due to the afterimage effect of the light that the eyes receive in the second period, the right-seat user 101b recognizes as if the image displayed in the second period is displayed also in the first period. Similarly, the left-seat user 101a cannot recognize that his eyes do not receive the light in the second period, and due to the afterimage effect of the light that the eyes receive in the first period, the left-seat user 101a recognizes as if the image displayed in the first period is displayed also in the second period.

In the configuration where the time division display device 250 is applied to the split view display 2, the left icon is displayed visibly in the first period when the parallax barrier 252 transmits the light from a plurality of pixels 251c in the direction of left seat, and the right icon is displayed visibly in the second period when the parallax barrier 252 transmits the light from the plurality of pixels 251c in the direction of right seat. Therefore, the outer peripheral portion of the display area of the left icon corresponds to some of the plurality of pixels 251c used to display the left icon, which are located at the outer peripheral portion, and the outer peripheral portion of the display area of the right icon corresponds to some of the plurality of pixels 251c used to display the right icon, which are located at the outer peripheral portion.

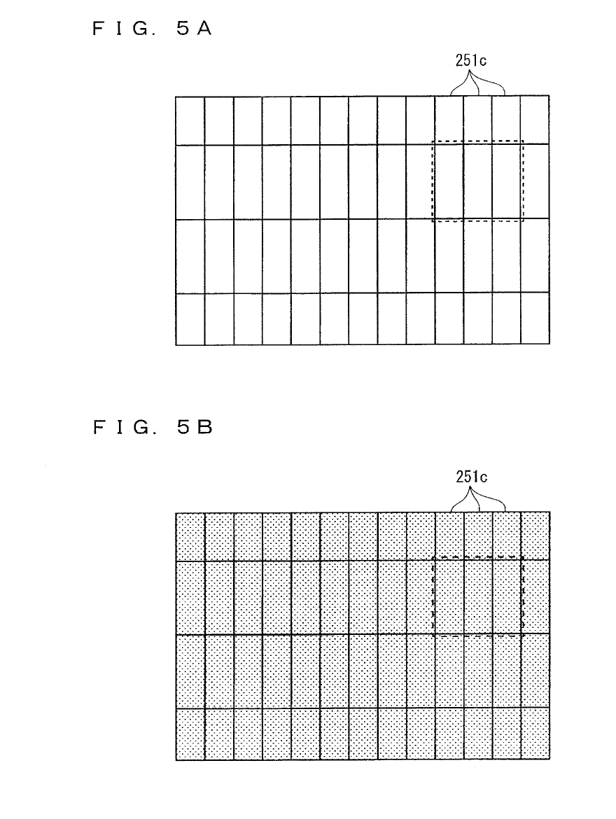

FIGS. 5A and 5B are views showing an example of display of the time-division type split view display 2 and shows the left image and the right image in one frame. A WVGA display device, for example, has 800 dots in the transverse direction (x axis) and 480 dots in the longitudinal direction (y axis) in total, as described above. Though depending on the performance of the display device, the time-division type split view display device shown in FIGS. 5A and 5B which corresponds to the WVGA display device, for example, has 800 dots of pixels 251c in the transverse direction and 480 dots of pixels 251c in the longitudinal direction. Herein, for simple illustration, however, description will be made assuming that the split view display device has 13 dots of pixels 251c in the transverse direction and 4 dots of pixels 251c in the longitudinal direction, and an icon is displayed with 3 dots of pixels 251c in the transverse direction and one dot of pixel 251c in the longitudinal direction.

In FIG. 5A, the outer peripheral portion (outer frame) of the left icon displayed in the first period is represented by a broken line, and this indicates that three pixels 251c arranged in the horizontal direction are used to display the left icon. In FIG. 5B, the outer peripheral portion (outer frame) of the right icon displayed in the second period is represented by a broken line, and this indicates that three pixels 251c arranged in the horizontal direction are used to display the right icon. Further, the number of pixels 251c used to display the left icon and the number of pixels 251c used to display the right icon are not each limited to three.

In the following description, in the configuration where the time division display device 250 is applied to the split view display 2, when at least one of the plurality of pixels 251c used to display the left icon in the first period coincides with at least one of the plurality of pixels 251c used to display the right icon in the second period, it will be described that at least part of the display area of the left icon and at least part of the display area of the right icon overlap each other on the screen of the split view display 2. On the other hand, when there is no pixel 251c which is used to display the left icon in the first period and also used to display the right icon in the second period, it will be described that the display area of the left icon and the display area of the right icon are separate from each other on the screen of the split view display 2.

Though detailed configuration will not be described, to the split view display 2, a combination type display device combining the space division type and the time division type may be applied. Then, for example, when at least part of the pixels used to display the left icon in the first period is sandwiched by some of the plurality of pixels used to display the right icon in the second period, which are located at the outer peripheral portion, or when at least part of the pixels used to display the right icon in the second period is sandwiched by some of the plurality of pixels used to display the left icon in the first period, which are located at the outer peripheral portion, it will be described that at least part of the display area of the left icon and at least part of the display area of the right icon overlap each other on the screen of the split view display 2. On the other hand, when either one of the pixel used to display the left icon in the first period and the pixel used to display the right icon in the second period is not sandwiched by the other pixels, it will be described that the display area of the left icon and the display area of the right icon are separate from each other on the screen of the split view display 2.

Further, a specific configuration of the display device using a split view type is disclosed in, for example, Japanese Patent Application Laid Open No. 2005-078080, International Publication No. WO 2012/070444, and the like. Though not mentioned in the above description, both in the space division type one and in the time division type one, the pixels are scanned in very short time period (for example, 1/30 (secs)).

Referring back to FIG. 1, a detection surface of the touch panel 3 (input unit) which receives an external operation is provided on the screen of the split view display 2. The touch panel 3 uniformly receives a first operation (hereinafter, referred to as an “operation for left” or a “left operation”) on the left image for performing a function of an application (function of a predetermined application) and a second operation (hereinafter, referred to as an “operation for right” or a “right operation”) on the right image for performing a function of another application. In the first preferred embodiment, with respect to an indicator, such as one or more fingers, which touches the detection surface, the touch panel 3 regularly detects a two-dimensional position of the indicator on the detection surface. Then, the touch panel 3 outputs a signal indicating the position of the indicator to the operation input processor 9.

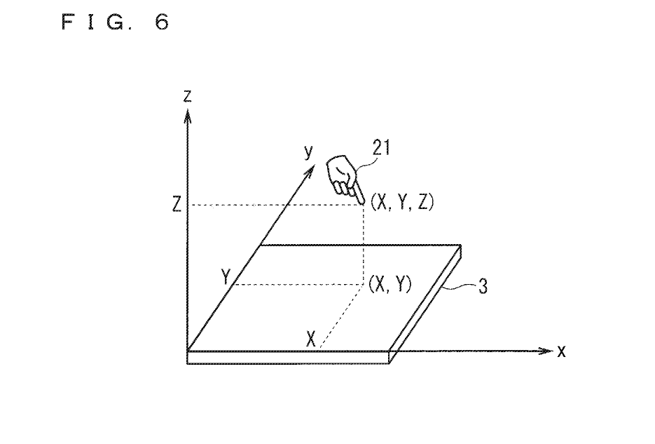

The touch panel 3, however, does not only detect the two-dimensional position, such as a (X, Y) coordinate value, as the position of the indicator. For example, as shown in FIG. 6, the touch panel 3 may detect a three-dimensional position (X, Y, Z) including the position (two-dimensional position) of a point on the detection surface where the distance from the indicator becomes shortest and a distance (Z-axis coordinate value which is another one-dimensional position) between the indicator and the detection surface (the point), as the position of the indicator.

The wireless communication unit 4 performs communications with a server, for example, through DSRC (Dedicate Short Range Communication) and a cellular phone or the like. The wireless communication unit 4 outputs information (for example, downloaded information) which is received from the server to the controller 14, and transmits information which is outputted from the controller 14 to the server. Further, the wireless communication unit 4 receives radio broadcasting and television broadcasting and outputs information acquired from the broadcasting to the controller 14.

The speaker (audio output unit) 5 outputs voice and sound on the basis of an audio signal outputted from the controller 14.

The DVD player 6 reproduces AV (Audio-video) information recorded in a DVD and outputs the AV information to the controller 14.

The air conditioner 7 adjusts the temperature and the humidity inside the self-vehicle by the control of the controller 14.

The in-vehicle LAN 8 performs communications with an ECU (Electronic Control Unit), a GPS (Global Positioning System) device, or the like, of the self-vehicle. The in-vehicle LAN 8 outputs, for example, the speed of the self-vehicle which is acquired from the ECU and the current position (for example, the longitude and latitude) of the self-vehicle which is acquired from the GPS device, to the controller 14.

The operation input processor 9 determines whether or not a gesture operation has been performed on the touch panel 3 and determines what type of gesture operation has been performed, on the basis of the output signal from the touch panel 3. Herein, the gesture operation includes a touch operation in which the indicator touches the detection surface of the touch panel 3 and a gesture operation (hereinafter, referred to as an “orbital gesture operation”) in which the indicator draws a predetermined orbit on the detection surface of the touch panel 3. Further, the orbital gesture operation may include a gesture operation in which two points are touched and then the touched two points are continuously used, or may include another gesture operation in which two points are touched and then one of the touched two points is separated and the other one point is continuously used.

In other words, the operation input processor 9 determines whether or not the touch operation has been performed as the gesture operation, on the basis of the output signal from the touch panel 3. Further, when it is determined that the touch operation has been performed, the operation input processor 9 determines how many points on the detection surface of the touch panel 3 are touched (how many indicators touch the detection surface). Therefore, the operation input processor 9 can determine whether or not an one-point touch operation in which the indicator touches the detection surface of the touch panel 3 with one point has been performed, whether or not a two-point touch operation in which the indicator touches the detection surface of the touch panel 3 with two points has been performed, or the like. Furthermore, though the description is made herein assuming that the two-point touch operation is an operation in which two indicators simultaneously touch the detection surface of the touch panel 3 with two points, the two-point touch operation is not limited to this operation but as the two-point touch operation, for example, the one-point touch operation which has been performed twice within a predetermined time period may be adopted.

Further, the operation input processor 9 determines whether or not the orbital gesture operation has been performed as the gesture operation, on the basis of the output signal from the touch panel 3. Herein, the orbital gesture operation includes, for example, a flick operation in which the indicator rubs the detection surface in a time shorter than a predetermined time period, a drag operation in which the indicator rubs the detection surface in a time longer than the predetermined time period, a pinch operation in which two indicators changes a distance therebetween while being in contact with the detection surface, and the like. The drag operation, however, is not limited to the above operation but as the drag operation, an operation in which the indicator rubs the detection surface while being in contact with the touch panel may be adopted. Further, the flick operation is not limited to the above operation but as the flick operation, an operation in which the indicator brushes the detection surface from a state of being in contact with the touch panel may be adopted.

Furthermore, to a first prescribed operation and a second prescribed operation described later, applied is the gesture operation. As described above, since the operation input processor 9 is configured to determine whether or not the gesture operation has been performed, for each type of gesture operation, it is possible to determine whether or not the first prescribed operation has been performed and determine whether or not the second prescribed operation has been performed.

Further, to the operation input processor 9, inputted is icon position information indicating the position of the icon displayed on the split view display 2, from the controller 14. The operation input processor 9 determines whether or not the touch operation or the gesture operation has been performed on the icon or the like displayed on the touch panel 3, in other words, on the split view display 2 on the basis of the icon position information and an output signal (signal indicating the position of the indicator) of the touch panel 3. For example, when the operation input processor 9 determines that the position of the indicator indicated by the output signal of the touch panel 3 overlaps the display area of the left icon (the indicator is located inside the left icon) or determines that the position of the indicator changes, overlapping the display area, (the position of the indicator changes, being located inside the display area), the operation input processor 9 determines that the gesture operation on the left icon has been performed. The operation input processor 9 also performs the same determination on the right icon as performed on the left icon.

The operation input processor 9 outputs the above determination result on the gesture operation or the like to the controller 14. Thus, though description is made in the first preferred embodiment, assuming that the operation input processor 9 performs the process in which it is determined whether or not the operation on the icon or the like displayed on the split view display 2 has been performed, the determination process may be performed by the controller 14. Further, though the operation input processor 9 is provided separately from the touch panel 3 and the controller 14 in FIG. 1, this is only one exemplary configuration. The operation input processor 9 may be included in the touch panel 3 as a function of the touch panel 3, or may be included in the controller 14 as a function of the controller 14.

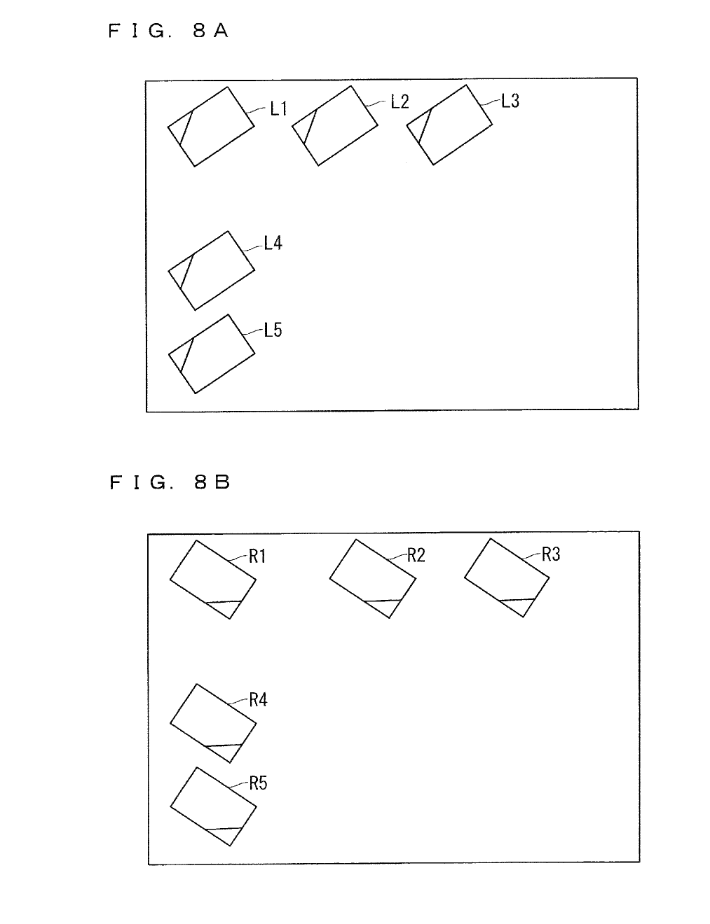

The storage 11 is a storage unit such as a hard disk drive, a DVD and a drive unit therefor, a BD (Blu-ray Disc) and a drive unit therefor, a semiconductor memory, or the like. The storage 11 stores therein a program which the controller 14 needs in operation and information to be used by the controller 14. The information to be used by the controller 14 includes, for example, an application (application software), an image in which an icon to be operated to perform a function of the application is arranged, map information, and the like. Further, in the following description, the image (for example, an image corresponding to FIG. 8A or 8B) in which an icon to be operated to perform a function of the application is arranged will be referred to as an “icon arrangement image”. The “icon arrangement image” also includes an image in which an icon is displayed in the map information.

The left image generator 12 generates a display signal used to display the left image on the basis of display information outputted from the controller 14 and outputs the display signal to the split view display 2. When the split view display 2 receives the display signal from the left image generator 12, the split view display 2 displays the left image on the basis of the display signal.

The right image generator 13 generates a display signal used to display the right image on the basis of display information outputted from the controller 14 and outputs the display signal to the split view display 2. When the split view display 2 receives the display signal from the right image generator 13, the split view display 2 displays the right image on the basis of the display signal.

Herein, the display signal generated by the left image generator 12 includes pixel numbers which are assigned to the plurality of pixels used to display the left image, respectively, in order of, for example, (1, 1), (2, 1) . . . , (800, 1), (1, 2), . . . , (800, 2), . . . , (800, 480). Similarly, the display signal generated by the right image generator 13 also includes pixel numbers which are assigned to the plurality of pixels used to display the right image, respectively, in order of, for example, (1, 1), (1, 2) . . . , (800, 480). For this reason, when the pixel number of at least one pixel used to display the left icon coincides with the pixel number of at least one pixel used to display the right icon, this corresponds to that at least part of the display area of the left icon and at least part of the display area of the right icon overlap each other on the screen of the split view display 2. Herein, the coordinates (x, y) are defined with the upper left of the screen as (1, 1) and indicate a pixel position corresponding to the xy coordinates where the x axis is positive in the right direction and the y axis is positive in the downward direction.

The controller 14 is, for example, a CPU (Central Processing Unit), and the CPU executes the program stored in the storage 11, to thereby perform various applications in the navigation apparatus 1 and further control the speaker 5 and the like in accordance with the application which is performed.

When the controller 14 performs an application for navigation, for example, on the basis of the current position of the self-vehicle, the destination based on the output signal from the touch panel 3, and the map information, the controller 14 searches for a route from the current position to the destination and generates display information to be used for displaying a guidance along the route and an audio signal to be used for outputting the guidance with voice and sound. As a result of this operation, the above-described guidance is displayed as the left image or the right image and the voice and sound for the above-described guidance is outputted from the speaker 5.

Further, when the controller 14 performs an application for reproduction of DVD, for example, the controller 14 generates display information to be used for displaying the AV information from the DVD player 6 and an audio signal to be used for outputting the AV information with voice and sound. As a result of this operation, a video image stored in the DVD is displayed as the left image or the right image and the voice and sound stored in the DVD are outputted from the speaker 5.

Furthermore, the controller 14 acquires one icon arrangement image corresponding to one or more applications which can be performed on the side of left image (can be performed from the side of left image) from the storage 11 and displays the acquired icon arrangement image as the left image. With this operation, an icon on which an operation is to be performed for performing a function of the application(s) on the side of left image is displayed on the split view display 2 (as the left image). In the following description, the icon arrangement image (for example, the image corresponding to FIG. 8A) which can be displayed as the left image will be referred to as an “icon arrangement image for left” or a “left icon arrangement image”. Further, the icon in the left icon arrangement image displayed as the left image corresponds to the above-described left icon.

Similarly, the controller 14 acquires one icon arrangement image corresponding to one or more applications which can be performed on the side of right image (can be performed from the side of right image) from the storage 11 and displays the acquired icon arrangement image as the right image. With this operation, an icon on which an operation is to be performed for performing a function of the application(s) on the side of right image is displayed on the split view display 2 (as the right image). In the following description, the icon arrangement image (for example, the image corresponding to FIG. 8B) which can be displayed as the right image will be referred to as an “icon arrangement image for right” or a “right icon arrangement image”. Further, the icon in the right icon arrangement image displayed as the right image corresponds to the above-described right icon.

Further, when the operation input processor 9 decides that the predetermined first prescribed operation has been performed, the controller 14 decides the first prescribed operation which is determined to have been performed, as the above-described left operation. On the other hand, when the operation input processor 9 determines that the predetermined second prescribed operation which is different from the first prescribed operation has been performed, the controller 14 decides the second prescribed operation which is determined to have been performed, as the above-described right operation.

Furthermore, in the first preferred embodiment, it is assumed that the first prescribed operation is a first gesture operation (hereinafter, referred to as a “first orbital gesture operation”) in which the indicator draws a predetermined first orbit on the touch panel 3. It is also assumed that the second prescribed operation is a second gesture operation (hereinafter, referred to as a “second orbital gesture operation”) in which the indicator draws a predetermined second orbit which is different from the first orbit on the touch panel 3. Hereinafter, description will be made, as an example, on a case where the first orbital gesture operation is the drag operation (hereinafter, referred to as an “upward-right drag operation”) drawing an upward-right (downward-left) linear orbit and the second orbital gesture operation is the drag operation (hereinafter, referred to as an “upward-left drag operation”) drawing an upward-left (downward-right) linear orbit.

Then, as described in detail below, the controller 14 is configured to cause the split view display 2 to display thereon the left icon which is capable of guiding the first prescribed operation (upward-right drag operation) to be performed and the right icon which is capable of guiding the second prescribed operation (upward-left drag operation) to be performed.

<Operation>

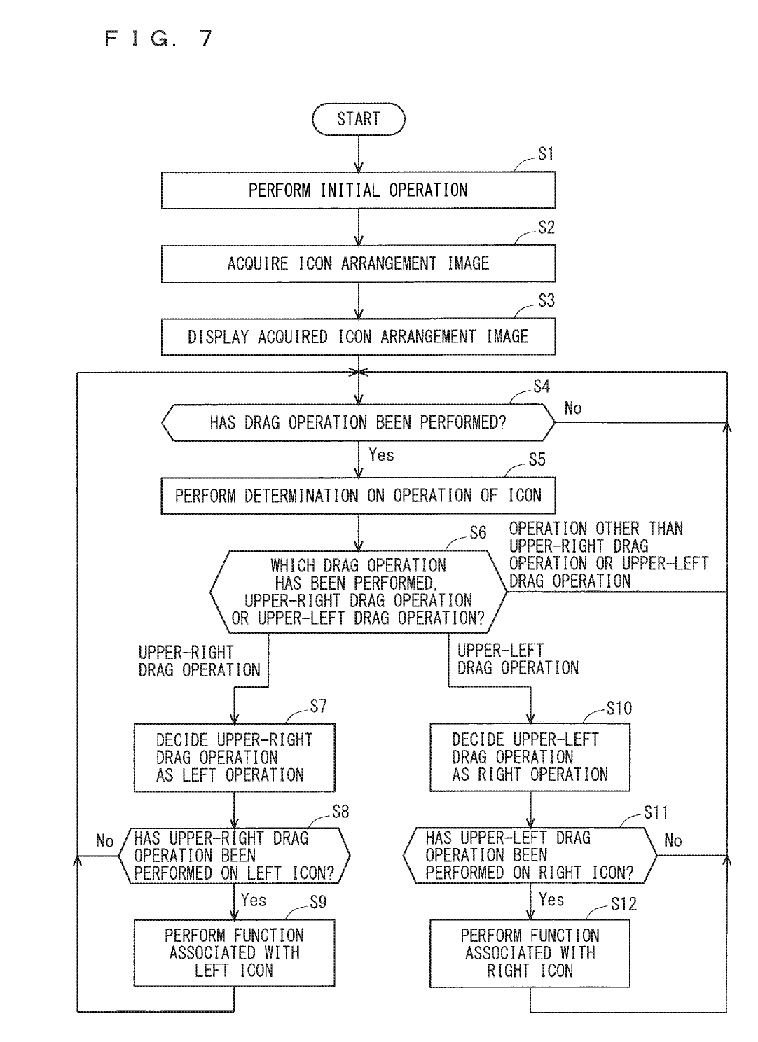

FIG. 7 is a flowchart showing an operation of the navigation apparatus 1 in accordance with the first preferred embodiment. The operation shown in FIG. 7 is performed when the CPU executes the program stored in the storage 11. Hereinafter, with reference to FIG. 7, the operation of the navigation apparatus 1 will be described.

In Step S1, first, when an operation used to perform an initial operation is performed, the controller 14 performs the initial operation. Herein, as the initial operation, the controller 14 acquires, from the storage 11, the applications to be performed initially on the side of left image and on the side of right image, and performs the applications.

In Step S2, from the storage 11, the controller 14 acquires the left icon arrangement image corresponding to the application which is being performed on the side of left image and acquires the right icon arrangement image corresponding to the application which is being performed on the side of right image.

In Step S3, the controller 14 displays the acquired left icon arrangement image as the left image of the split view display 2 and the acquired right icon arrangement image as the right image of the split view display 2.

FIGS. 8A and 8B are views showing an example of display of the left image and the right image, respectively, in the navigation apparatus 1 (the split view display 2) in accordance with the first preferred embodiment in Step S3. FIG. 8A shows an example of display of the left image in which left icons L1, L2, L3, L4, and L5 (hereinafter, these icons are sometimes collectively referred to as “left icons L1 to L5”) are displayed. FIG. 8B shows an example of display of the right image in which right icons R1, R2, R3, R4, and R5 (hereinafter, these icons are sometimes collectively referred to as “right icons R1 to R5”) are displayed.

In the exemplary displays of FIGS. 8A and 8B, at least part of the display areas of the left icons L1 to L5 and at least part of the display areas of the right icons R1 to R5 overlap each other on the screen of the split view display 2. In the first preferred embodiment, it is assumed that the controller 14 acquires, from the storage 11, the left icon arrangement image and the right icon arrangement image in which at least respective parts of the display areas of icons overlap each other on the screen of the split view display 2, and causes the split view display 2 to display thereon these images, to thereby achieve the respective displays shown in FIGS. 8A and 8B.

Herein, an outer frame shape of each of the left icons L1 to L5 shown in FIG. 8A corresponds to the linear orbit of the upward-right drag operation (the first orbit of the first orbital gesture operation). Specifically, the longitudinal direction of each of the left icons L1 to L5 is aligned with the extension direction of a straight line to be drawn by the upward-right drag operation (first prescribed operation). The left-seat user can perform the upward-right drag operation, in other words, the first prescribed operation by using such an icon display as a clue. Thus, in Step S3, the controller 14 causes the split view display 2 to display thereon the left icons L1 to L5 which are capable of guiding the first prescribed operation to be performed.

Similarly, an outer frame shape of each of the right icons R1 to R5 shown in FIG. 8B corresponds to the linear orbit of the upward-left drag operation (the second orbit of the second orbital gesture operation). Specifically, the longitudinal direction of each of the right icons R1 to R5 is aligned with the extension direction of a straight line to be drawn by the upward-left drag operation (second prescribed operation). The right-seat user can perform the upward-left drag operation, in other words, the second prescribed operation by using such an icon display as a clue. Thus, in Step S3, the controller 14 causes the split view display 2 to display thereon the right icons R1 to R5 which are capable of guiding the second prescribed operation to be performed.

In Step S4 of FIG. 7, the operation input processor 9 determines whether or not the drag operation has been performed. When it is determined that the drag operation has been performed, the process goes to Step S5, and when it is not determined that the drag operation has been performed, Step S4 is performed again. Further, when Step S4 is performed again, if the map is displayed as the left image or the right image and the position of the self-vehicle has been changed, the controller 14 may scroll the map in accordance with the change of the position.

In Step S5, the operation input processor 9 determines whether the drag operation in Step S4 has been performed on the left icon or the right icon. Further, the determination result will be used in Step S8 or S11.

In Step S6, the operation input processor 9 determines whether the drag operation in Step S4 has been performed as the upward-right drag operation or the upward-left drag operation, or an operation other than these drag operations.

When it is determined that the upward-right drag operation has been performed, the process goes to Step S7, when it is determined that the upward-left drag operation has been performed, the process goes to Step S10, and when it is determined that the operation other than these drag operations has been performed, the process goes back to Step S4. Further, when the process goes back to Step S4, if the map is displayed as the left image or the right image and the position of the self-vehicle has been changed, the controller 14 may scroll the map in accordance with the change of the position. The same applies to the case where the process goes back to Step S4 from the steps other than Steps S6.

When the process goes to Step S7 from Step S6, in Step S7, the controller 14 decides the drag operation in Step S4, in other words, the upward-right drag operation as the left operation.

In Step S8, the controller 14 determines whether or not the upward-right drag operation which is decided as the left operation has been performed on the left icon, on the basis of the determination result in Step S5. When it is determined that the upward-right drag operation has been performed on the left icon, the process goes to Step S9, and otherwise the process goes back to Step S4.

In Step S9, the controller 14 performs a function which is associated in advance with the left icon on which the upward-right drag operation has been performed. After that, the process goes back to Step S4. Further, when the icon arrangement image which is associated with the left icon in advance is stored in the storage 11, there may be a case where the process goes back from Step S9 to Step S3 and the icon arrangement image is displayed on the split view display 2.

When the process goes to Step S10 from Step S6, in Step S10, the controller 14 decides the drag operation in Step S4, in other words, the upward-left drag operation as the right operation.

In Step S11, the controller 14 determines whether or not the upward-left drag operation which is decided as the right operation has been performed on the right icon, on the basis of the determination result in Step S5. When it is determined that the upward-left drag operation has been performed on the right icon, the process goes to Step S12, and otherwise the process goes back to Step S4.

In Step S12, the controller 14 performs a function which is associated in advance with the right icon on which the upward-left drag operation has been performed. After that, the process goes back to Step S4. Further, when the icon arrangement image which is associated with the right icon in advance is stored in the storage 11, there may be a case where the process goes back from Step S12 to Step S3 and the icon arrangement image is displayed on the split view display 2.

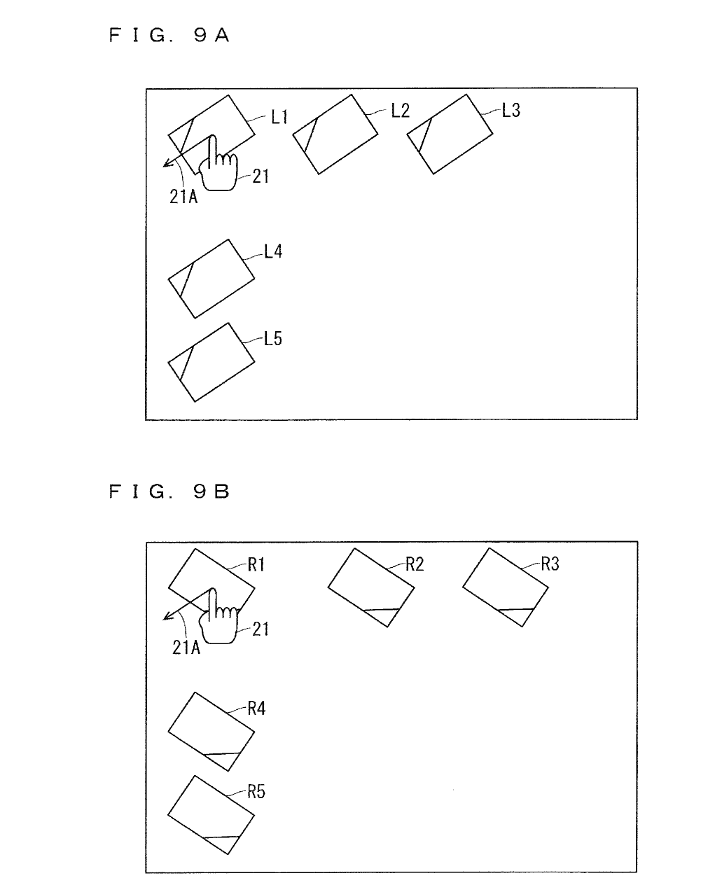

An example of the above-described operation shown in FIG. 7 will be described. As shown in FIGS. 9A and 9B, for example, it is assumed that the upward-right drag operation by a finger 21 which is an indicator has been performed on the left icon L1 and the right icon R1 (an arrow 21A in FIGS. 9A and 9B indicates an orbit of the finger 21 in the upward-right drag operation). In other words, it is assumed that the upward-right drag operation along the longitudinal direction of the left icon L1 has been performed on the left icon L1 and the right icon R1. In this case, the controller 14 decides the upward-right drag operation as the left operation. As a result of this decision, the controller 14 performs the function associated with the left icon L1, not the function associated with the right icon R1.

On the other hand, as shown in FIGS. 10A and 10B, for example, it is assumed that the upward-left drag operation by the finger 21 has been performed on the left icon L1 and the right icon R1 (an arrow 21B in FIGS. 10A and 10B indicates an orbit of the finger 21 in the upward-left drag operation). In other words, it is assumed that the upward-left drag operation along the longitudinal direction of the right icon R1 has been performed on the left icon L1 and the right icon R1. In this case, the controller 14 decides the upward-left drag operation as the right operation. As a result of this decision, the controller 14 performs the function associated with the right icon R1, not the function associated with the left icon L1.

<Effects>

By the navigation apparatus 1 in accordance with the first preferred embodiment described above, when it is determined that the first prescribed operation (herein, the upward-right drag operation) has been performed, the first prescribed operation is decided as the left operation, and when it is determined that the second prescribed operation (herein, the upward-left drag operation) has been performed, the second prescribed operation is decided as the right operation. Therefore, by performing the first prescribed operation, the left-seat user can avoid unintentionally performing the application for the right-seat user and perform the application for the left-seat user. Similarly, by performing the second prescribed operation, the right-seat user can avoid unintentionally performing the application for the left-seat user and perform the application for the right-seat user. In other words, among the functions of the applications on the left image side and on the right image side, the user can perform the function which the user desires to perform. As a result of this operation, since it is possible to achieve an arrangement in which at least part of the display area of the left icon and at least part of the display area of the right icon overlap each other on the screen of the split view display 2, in a process for generating the icon arrangement image, it is possible to suppress a shortage of area for arranging the icons and reduce the constraint on the arrangement of icons.

Further, according to the first preferred embodiment, the left icons L1 to L5 which are capable of guiding the first prescribed operation (herein, the upward-right drag operation) to be performed are displayed. Therefore, with the display as a clue, the left-seat user can know what the first prescribed operation is like before performing the operation. Similarly, the right icons R1 to R5 which are capable of guiding the second prescribed operation (herein, the upward-left drag operation) to be performed are displayed. Therefore, with the display as a clue, the right-seat user can know what the second prescribed operation is like before performing the operation.

### The First Variation of the First Preferred Embodiment

In the first preferred embodiment, as shown in FIGS. 8A and 8B, the controller 14 causes the split view display 2 to display thereon the left icons L1 to L5 and the right icons R1 to R5 which are still images. The left icons L1 to L5, however, may not be still image icons only if these icons are capable of guiding the first prescribed operation to be performed, and similarly, the right icons R1 to R5 may not be still image icons only if these icons are capable of guiding the second prescribed operation to be performed.

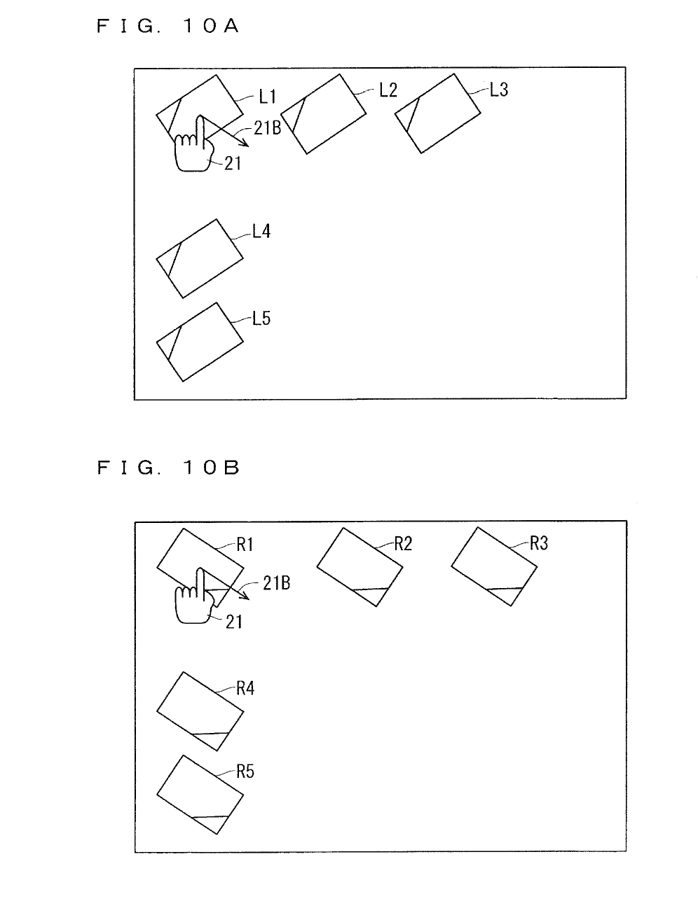

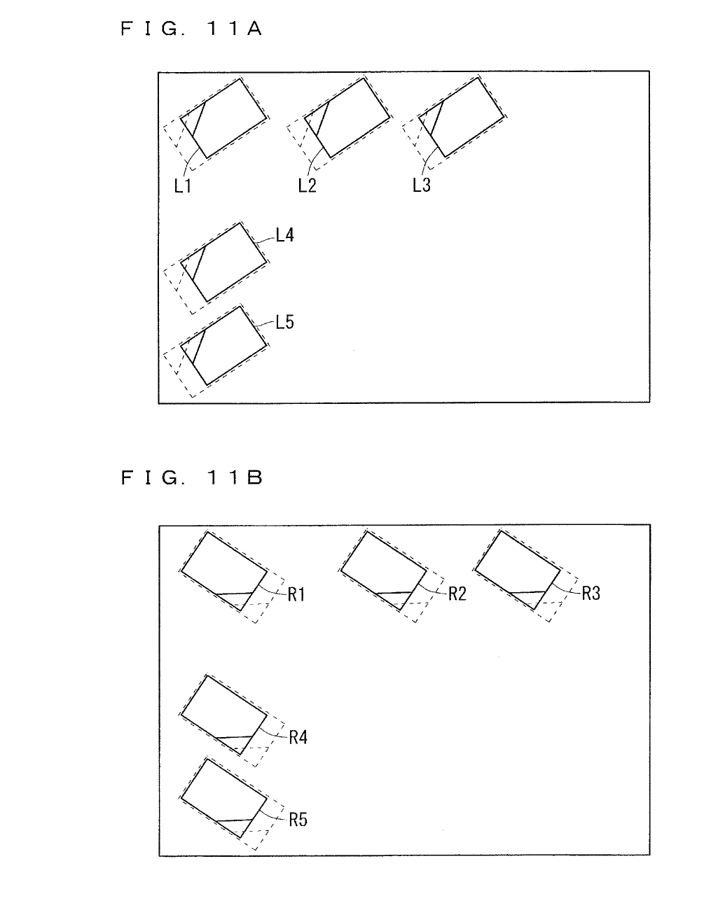

As shown in FIGS. 11A and 11B, for example, the controller 14 may cause the split view display 2 to display thereon the left icons L1 to L5 and the right icons R1 to R5 which are moving images in which shapes represented by solid lines and shapes represented by broken lines are alternately displayed. In other words, the controller 14 may cause the split view display 2 to display thereon at least one of the left icons L1 to L5 and the right icons R1 to R5 by animation (in a form of moving image). The animation is performed in such an expression manner as to guide at least one of the first prescribed operation and the second prescribed operation to be performed.

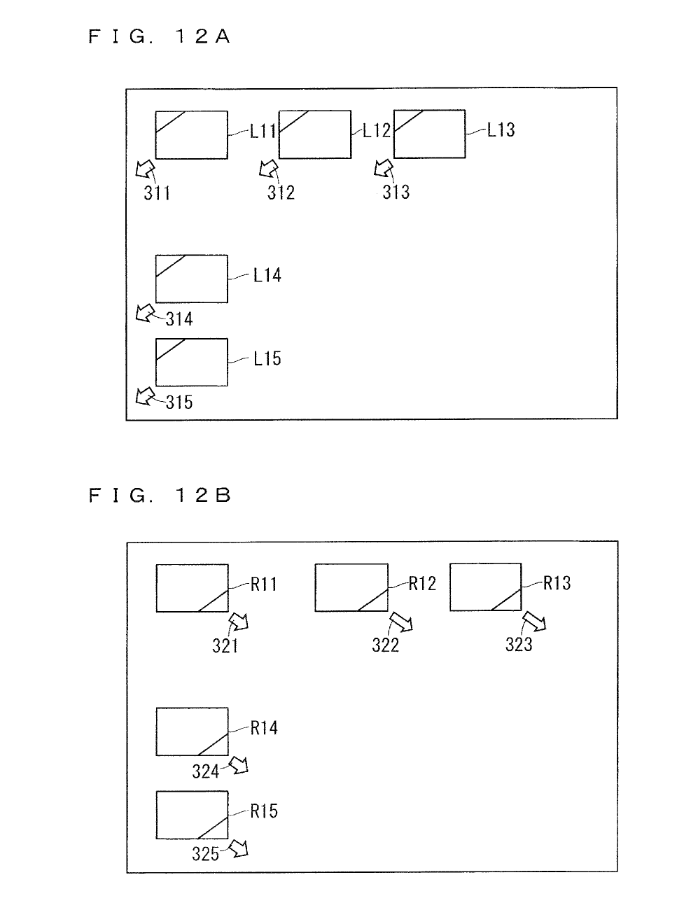

Further, as shown in FIG. 12A, the controller 14 may cause the split view display 2 to display thereon normal left icons L11, L12, L13, L14, and L15 (hereinafter, referred to as “left icons L11 to L15”) and arrows 311, 312, 313, 314, and 315 (hereinafter, referred to as “arrows 311 to 315”) which are capable of guiding the first prescribed operation (herein, the upward-right drag operation) to be performed. In FIG. 12A, since a shape of each of the arrows 311 to 315 (first display objects) corresponds to the linear orbit of the upward-right drag operation (the first orbit of the first orbital gesture operation), the arrows 311 to 315 are capable of guiding the first prescribed operation to be performed. Furthermore, to the normal left icons L11 to L15, for example, applied are left icons which do not explicitly guide the first prescribed operation to be performed.

Similarly, as shown in FIG. 12B, the controller 14 may cause the split view display 2 to display thereon normal right icons R11, R12, R13, R14, and R15 (hereinafter, referred to as “right icons R11 to R15”) and arrows 321, 322, 323, 324, and 325 (hereinafter, referred to as “arrows 321 to 325”) which are capable of guiding the second prescribed operation (herein, the upward-left drag operation) to be performed. In FIG. 12B, since a shape of each of the arrows 321 to 325 (second display objects) corresponds to the linear orbit of the upward-left drag operation (the second orbit of the second orbital gesture operation), the arrows 321 to 325 are capable of guiding the second prescribed operation to be performed. Furthermore, to the normal right icons R11 to R15, for example, applied are right icons which do not explicitly guide the second prescribed operation to be performed.

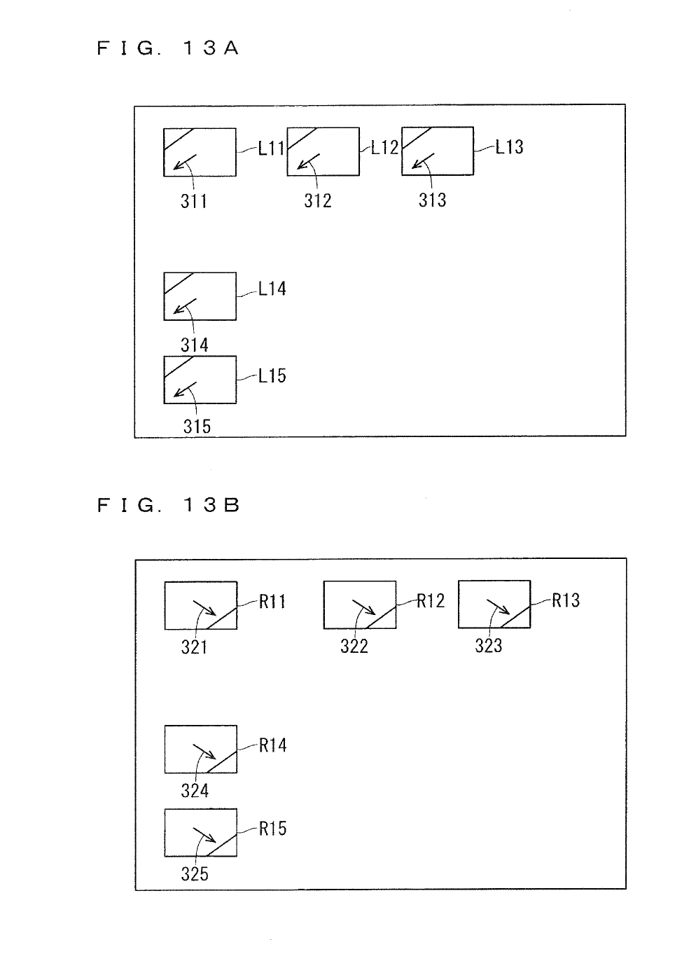

As another example, as shown in FIG. 13A, the controller 14 may cause the split view display 2 to display thereon the arrows 311 to 315 arranged overlapping the left icons L11 to L15, respectively, instead of the arrows 311 to 315 arranged near the left icons L11 to L15, respectively, shown in FIG. 12A. Similarly, as shown in FIG. 13B, the controller 14 may cause the split view display 2 to display thereon the arrows 321 to 325 arranged overlapping the right icons R11 to R15, respectively, instead of the arrows 321 to 325 arranged near the right icons R11 to R15, respectively, shown in FIG. 12B. Further, the arrows 311 to 315 and the arrows 321 to 325 shown in FIGS. 13A and 13B, respectively, may be defined as parts of the left icons and the right icons, not as the first display objects and the second display objects.

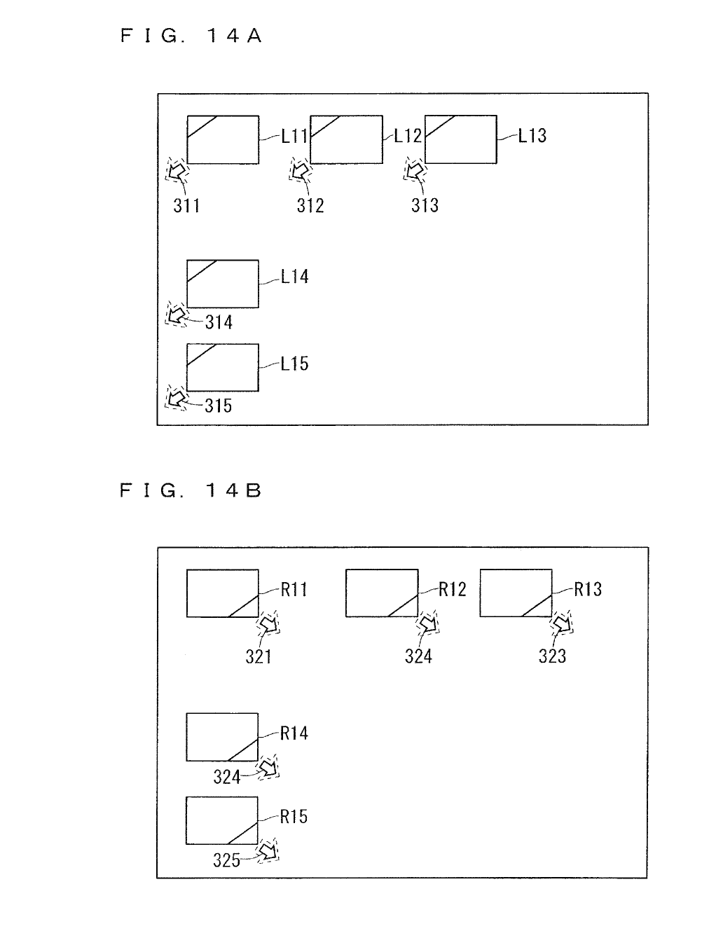

Furthermore, as shown in FIG. 14A, the controller 14 may cause the split view display 2 to display thereon the arrows 311 to 315 which are moving images in which shapes represented by solid lines and shapes represented by broken lines are alternately displayed, instead of the arrows 311 to 315 which are still images shown in FIGS. 12A and 13A. Similarly, as shown in FIG. 14B, the controller 14 may cause the split view display 2 to display thereon the arrows 321 to 325 which are moving images in which shapes represented by solid lines and shapes represented by broken lines are alternately displayed, instead of the arrows 321 to 325 which are still images shown in FIGS. 12B and 13B. In other words, the controller 14 may display at least one of the arrows 311 to 315 in the left image and the arrows 321 to 325 in the right image by animation (in a form of moving image). By adopting this configuration, the left-seat user can know what the first prescribed operation is like more specifically and the right-seat user can know what the second prescribed operation is like more specifically.

Further, the controller 14 may cause the split view display 2 to simultaneously display thereon the left icons L1 to L5 shown in FIG. 8A which are capable of guiding the first prescribed operation to be performed and the arrows 311 to 315 shown in FIG. 12A which are capable of guiding the first prescribed operation to be performed. Similarly, the controller 14 may cause the split view display 2 to simultaneously display thereon the right icons R1 to R5 shown in FIG. 8B which are capable of guiding the second prescribed operation to be performed and the arrows 321 to 325 shown in FIG. 12B which are capable of guiding the second prescribed operation to be performed. Furthermore, in this configuration, the controller 14 may display at least one of the left icons L1 to L5, the arrows 311 to 315, the right icons R1 to R5, and the arrows 321 to 325 by animation (in a form of moving image).

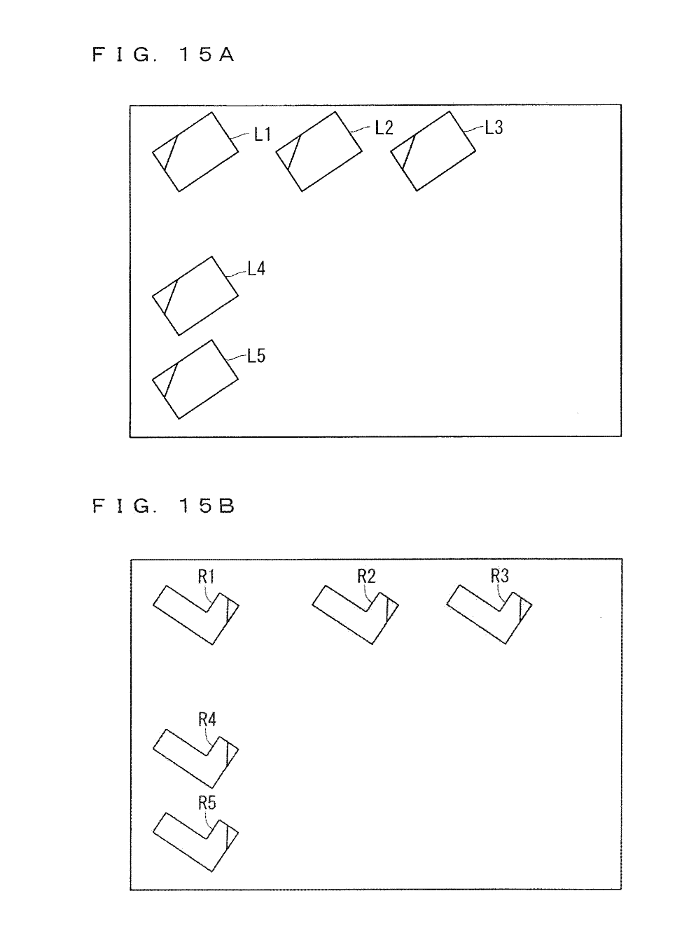

The first orbit of the first orbital gesture operation and the second orbit of the second orbital gesture operation are not limited to the above-described ones only if these have different shapes of orbit. There may be a case, for example, where the first orbit has an upward-right (downward-left) linear shape and the second orbit has a V shape. In such a configuration, the controller 14 may cause the split view display 2 to display thereon the left icons L1 to L5 each having an outer frame of linear shape (rectangle), which are capable of guiding the first orbital gesture operation drawing the first orbit having an upward-right (downward-left) linear shape to be performed, as shown in FIG. 15A, and the right icons R1 to R5 each having an outer frame of V shape, which are capable of guiding the second orbital gesture operation drawing the second orbit having a V shape to be performed, as shown in FIG. 15B. Further, though description is made herein assuming that the first orbit has an upward-right (downward-left) linear shape and the second orbit has a V shape, the respective shapes of the first orbit and the second orbit are not limited to these ones, but naturally the first orbit may have a V shape and the second orbit may have an upward-left (downward-right) linear shape.

In the first preferred embodiment, each of the first orbital gesture operation applied to the first prescribed operation and the second orbital gesture operation applied to the second prescribed operation is a kind of drag operation. These orbital gesture operations, however, are not limited to the drag operation but, for example, the first orbital gesture operation may be the flick operation or the pinch operation drawing the first orbit on the touch panel 3 and the second orbital gesture operation may be the flick operation or the pinch operation drawing the second orbit which is different from the first orbit on the touch panel 3.

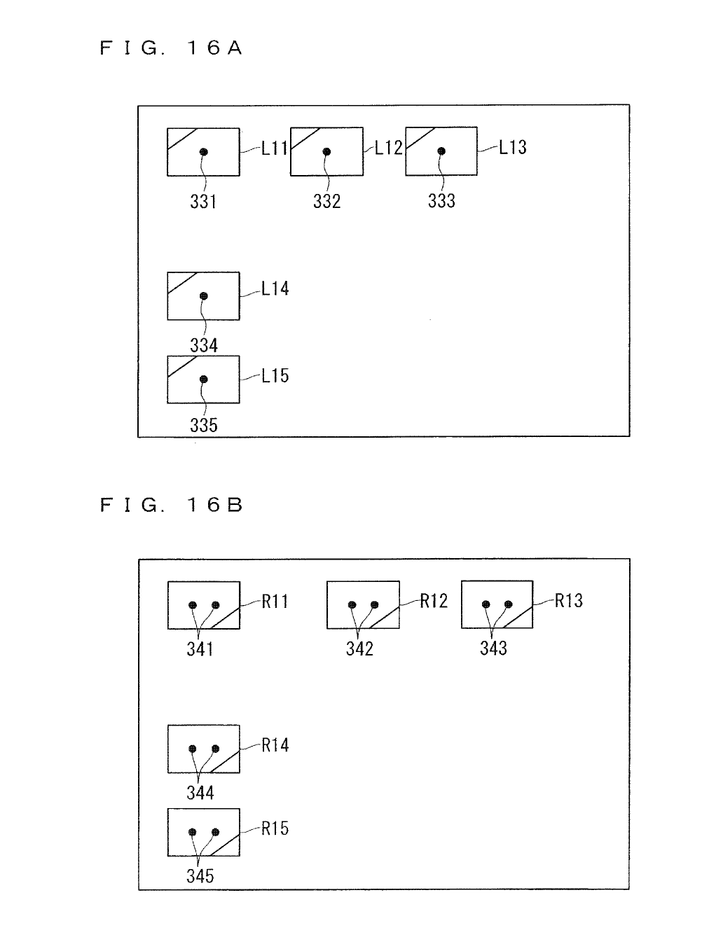

Further, the first prescribed operation may be a first touch operation in which the indicator touches the touch panel 3 with a predetermined first number of points, instead of the first orbital gesture operation drawing the first orbit on the touch panel 3. Then, in the configuration where the first touch operation is the one-point touch operation (the first number is “1”), for example, as shown in FIG. 16A, the controller 14 may cause the split view display 2 to display thereon the normal left icons L11 to L15 and points 331, 332, 333, 334, and 335 (hereinafter, referred to as “points 331 to 335”) which are capable of guiding the first prescribed operation (one-point touch operation) to be performed. In FIG. 16A, since the number of each of the points 331 to 335 (first display objects) is equal to the first number (herein, “1”) of the first touch operation, the points 331 to 335 are capable of guiding the first prescribed operation to be performed.

By adopting such a configuration, like in the first preferred embodiment, the left-seat user can know what the first prescribed operation is like before performing the operation.

Similarly, the second prescribed operation may be a second touch operation in which the indicator touches the touch panel 3 with a predetermined second number of points, the number of which is different from the first number, instead of the second orbital gesture operation drawing the second orbit on the touch panel 3. Then, in the configuration where the second touch operation is the two-point touch operation (the second number is “2”), for example, as shown in FIG. 16B, the controller 14 may cause the split view display 2 to display thereon the normal right icons R11 to R15 and points 341, 342, 343, 344, and 345 (hereinafter, referred to as “points 341 to 345”) which are capable of guiding the second prescribed operation (two-point touch operation) to be performed. In FIG. 16B, since the number of each of the points 341 to 345 (second display objects) is equal to the second number (herein, “2”) of the second touch operation, the points 341 to 345 are capable of guiding the second prescribed operation to be performed.

By adopting such a configuration, like in the first preferred embodiment, the right-seat user can know what the second prescribed operation is like before performing the operation.

Further, the points 331 to 335 and the points 341 to 345 shown in FIGS. 16A and 16B, respectively, may be defined as parts of the left icons and the right icons, not as the first display objects and the second display objects.

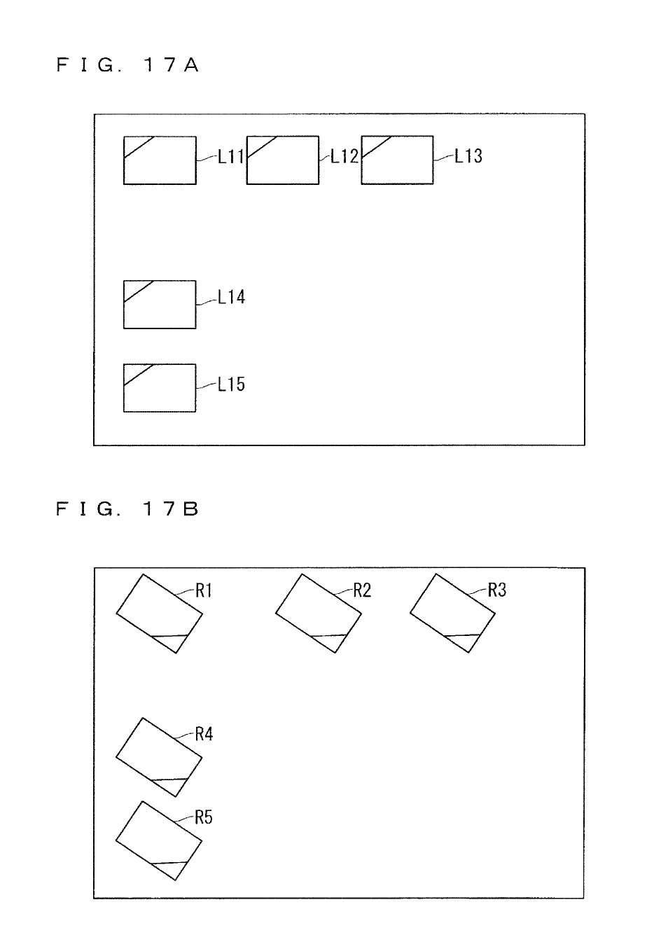

Furthermore, there may be a case where one of the first prescribed operation and the second prescribed operation is a touch operation and the other operation is an orbital gesture operation. In a case, for example, where the first prescribed operation is the touch operation and the second prescribed operation is the orbital gesture operation, the controller 14 may display the left icons L11 to L15 and the points 331 to 335 shown in FIG. 16A in the left image and also display the right icons R1 to R5 shown in FIG. 8B in the right image. As another example, the controller 14 may display the normal left icons L11 to L15 shown in FIG. 17A in the left image and also display the same right icons R1 to R5 as shown in FIG. 8B in the right image as shown in FIG. 17B.

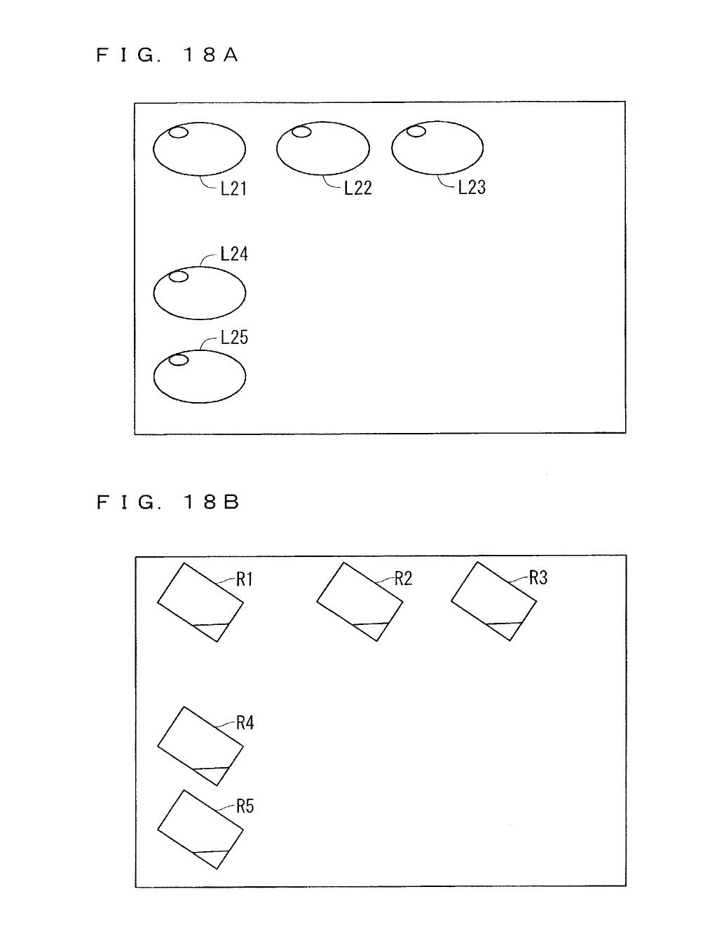

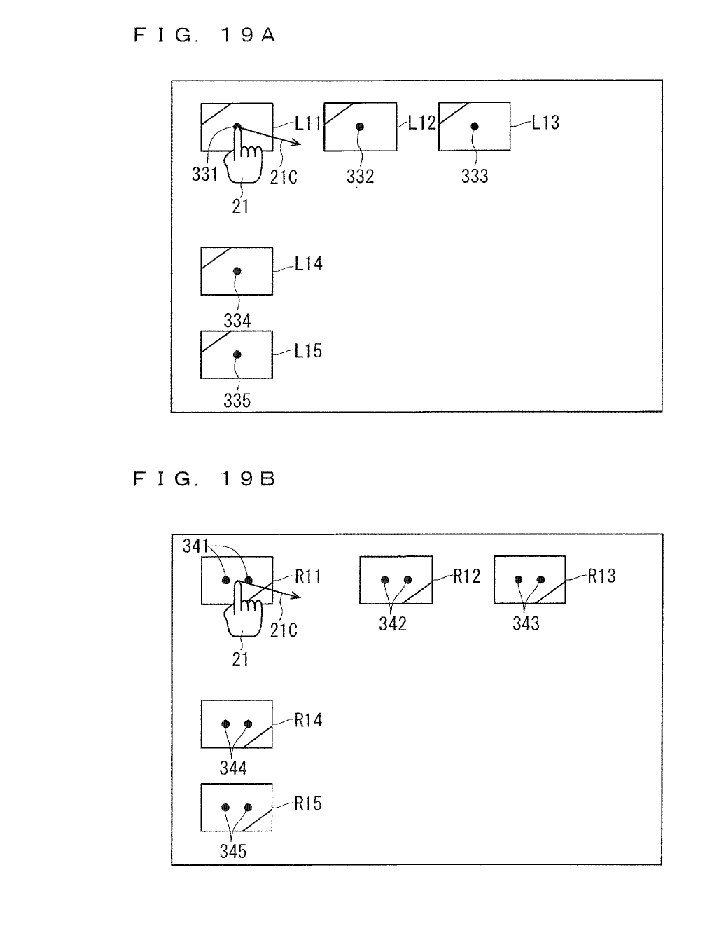

Moreover, as still another example of the case where the first prescribed operation is the touch operation and the second prescribed operation is the orbital gesture operation, the controller 14 may display left icons L21, L22, L23, L24, and L25 (hereinafter, referred to as “left icons L21 to L25”) shown in FIG. 18A in the left image and also display the right icons R1 to R5 shown in FIG. 18B in the right image. In the exemplary case shown in FIGS. 18A and 18B, an outer frame shape of each of the left icons L21 to L25 which are objects on which the touch operation is to be performed is an ellipse and different from the outer frame shape (rectangle) of each of the right icons R1 to R5 which are objects on which the orbital gesture operation is to be performed. In other words, in the configuration shown in FIGS. 18A and 18B, the shapes (outer frame shapes) of the left icon and the right icon correspond to the first prescribed operation (touch operation) and the second prescribed operation (orbital gesture operation), respectively.

### The Second Variation of the First Preferred Embodiment

In the first preferred embodiment, when it is determined that the first prescribed operation has been performed, the first prescribed operation is decided as the left operation. This, however, is only one exemplary case, and instead of deciding the first prescribed operation as the left operation, a gesture operation (the touch operation or the orbital gesture operation) after the first prescribed operation may be decided as the left operation. In other words, when the operation input processor 9 determines that the gesture operation after the first prescribed operation has been performed, the controller 14 may decide the gesture operation which is determined to have been performed, as the left operation.

In a configuration where the first prescribed operation is the one-point touch operation, for example, as shown in FIGS. 19A and 19B, it is assumed that the drag operation after the one-point touch operation by the finger 21 has been performed on the left icon L11 and the right icon R11 (an arrow 21C in FIGS. 19A and 19B indicates an orbit of the finger 21 in the drag operation). In this case, the controller 14 may decide the drag operation as the left operation on the left icon L11. The same applies to a case where the flick operation or the like, instead of the drag operation, is adopted as the gesture operation after the first prescribed operation. This operation is applied to, for example, a map scrolling function or the like for which the operation is performed outside an icon.

Further, in the first preferred embodiment, when it is determined that the second prescribed operation has been performed, the second prescribed operation is decided as the right operation. This, however, is only one exemplary case, and instead of deciding the second prescribed operation as the right operation, a gesture operation (the touch operation or the orbital gesture operation) after the second prescribed operation may be decided as the right operation. In other words, when the operation input processor 9 determines that the gesture operation after the second prescribed operation has been performed, the controller 14 may decide the gesture operation which is determined to have been performed, as the right operation.

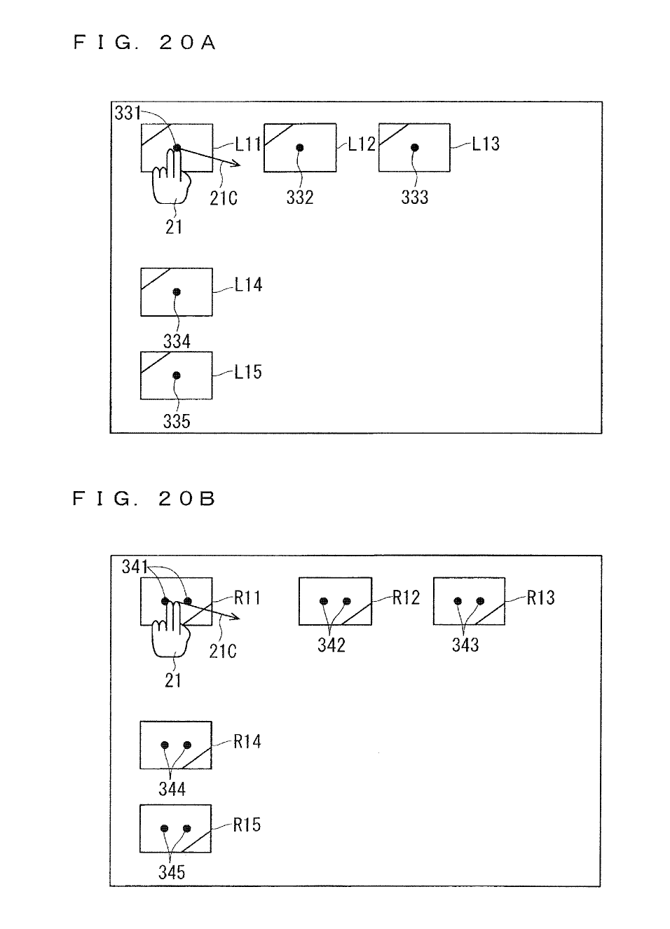

In a configuration where the second prescribed operation is the two-point touch operation, for example, as shown in FIGS. 20A and 20B, it is assumed that the drag operation after the two-point touch operation by the fingers 21 has been performed on the left icon L11 and the right icon R11 (an arrow 21C in FIGS. 20A and 20B indicates an orbit of the fingers 21 in the drag operation). In this case, the controller 14 may decide the drag operation as the right operation on the right icon R11. The same applies to a case where the flick operation or the like, instead of the drag operation, is adopted as the gesture operation after the second prescribed operation.

By adopting the above-described configuration, with respect to the gesture operation after the first prescribed operation and the second prescribed operation, it is possible to produce the same effects as those in the first preferred embodiment.

### The Second Preferred Embodiment

Since the constitution of the navigation apparatus 1 in accordance with the second preferred embodiment, which is represented by the block diagram, is the same as that in the first preferred embodiment, illustration thereof will be omitted. Then, in the navigation apparatus 1 in accordance with the second preferred embodiment, constituent elements identical or similar to those described in the first preferred embodiment are represented by the same reference signs, and the following description will be made, centering on the difference therebetween.

Further, it is assumed that the split view display 2 in accordance with the second preferred embodiment displays thereon a left icon (the second icon), a transformed left icon therefrom (the first icon), a right icon (the fourth icon), and a transformed right icon therefrom (the third icon).

When the indicator such as the finger 21 of the user (a driver or a fellow passenger sitting on the front passenger seat) or the like comes close to the detection surface (see FIG. 6), the touch panel 3 in accordance with the second preferred embodiment detects the position (X, Y) of the point on the detection surface where the distance from the indicator becomes shortest and a distance Z between the indicator and the detection surface, as the three-dimensional position of the indicator. When the distance Z is zero, this indicates that the finger 21 touches the detection surface of the touch panel 3.

The operation input processor 9 in accordance with the second preferred embodiment not only performs the determination described in the first preferred embodiment but also determines whether or not a first action (hereinafter, referred to as a “first prior action”) which is defined in advance as an action before performing the first prescribed operation has been performed, on the basis of the output signal (the signal indicating the three-dimensional position of the indicator) from the touch panel 3. Herein, the operation input processor 9 determines that the first prior action has been performed when the operation input processor 9 determines that the distance Z indicated by the output signal from the touch panel 3 has become larger than zero and not larger than a predetermined first threshold value ZL (for example, about 3 to 10 cm), and the operation input processor 9 determines that the first prior action has not been performed when the operation input processor 9 determines that the distance Z is larger than the first threshold value ZL.

Similarly, the operation input processor 9 determines whether or not a second action (hereinafter, referred to as a “second prior action”) which is defined in advance as an action before performing the second prescribed operation has been performed, on the basis of the output signal (the signal indicating the three-dimensional position of the indicator) from the touch panel 3. Herein, the operation input processor 9 determines that the second prior action has been performed when the operation input processor 9 determines that the distance Z indicated by the output signal from the touch panel 3 has become larger than zero and not larger than a predetermined second threshold value ZR (for example, about 3 to 10 cm), and the operation input processor 9 determines that the second prior action has not been performed when the operation input processor 9 determines that the distance Z is larger than the second threshold value ZR.

Further, though the first threshold value ZL may be a value different from the second threshold value ZR, it is assumed herein that the first threshold value ZL is the same value as the second threshold value ZR, for simple description. In such a configuration, the determination on whether or not the first prior action has been performed is substantially the same as the determination on whether or not the second prior action has been performed.

As described in detail later, when it is determined on the basis of the output signal from the touch panel 3 that the first prior action has been performed, the controller 14 in accordance with the second preferred embodiment transforms a normal left icon (second icon) into a left icon (first icon) which is capable of guiding the first prescribed operation to be performed. Specifically, when it is determined on the basis of the output signal from the touch panel 3 that the distance Z has become larger than zero and not larger than the first threshold value ZL, the controller 14 transforms the normal left icon into the left icon which is capable of guiding the first prescribed operation to be performed. Further, in the second preferred embodiment, like in the first preferred embodiment, it is assumed that the first prescribed operation is the upward-right drag operation.

Similarly, when it is determined on the basis of the output signal from the touch panel 3 that the second prior action has been performed, the controller 14 transforms a normal right icon (fourth icon) into a right icon (third icon) which is capable of guiding the second prescribed operation to be performed. Specifically, when it is determined on the basis of the output signal from the touch panel 3 that the distance Z has become larger than zero and not larger than the second threshold value ZR, the controller 14 transforms the normal right icon into the right icon which is capable of guiding the second prescribed operation to be performed. Further, in the second preferred embodiment, like in the first preferred embodiment, it is assumed that the second prescribed operation is the upward-left drag operation.

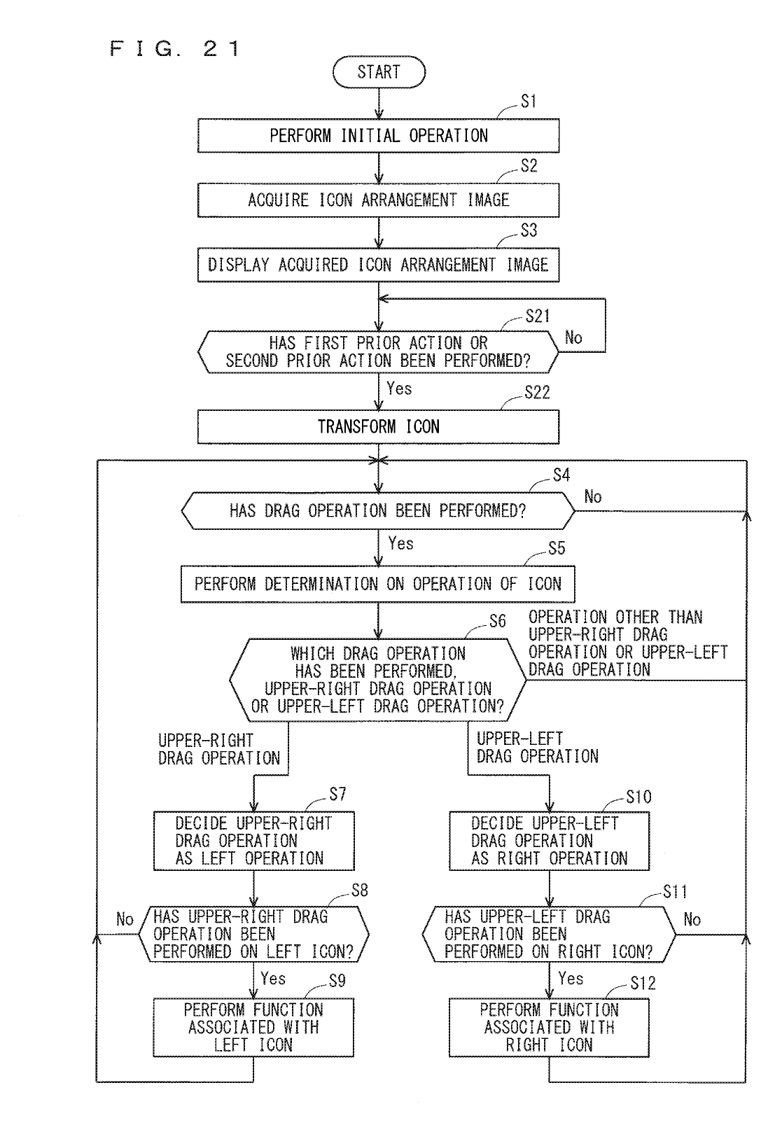

FIG. 21 is a flowchart showing an operation of the navigation apparatus 1 in accordance with the second preferred embodiment. In the flowchart of FIG. 21, since Steps S21 and S22 are added between Steps S3 and S4 in the flowchart of FIG. 7, the following description will be made, centering on Steps S21 and S22.

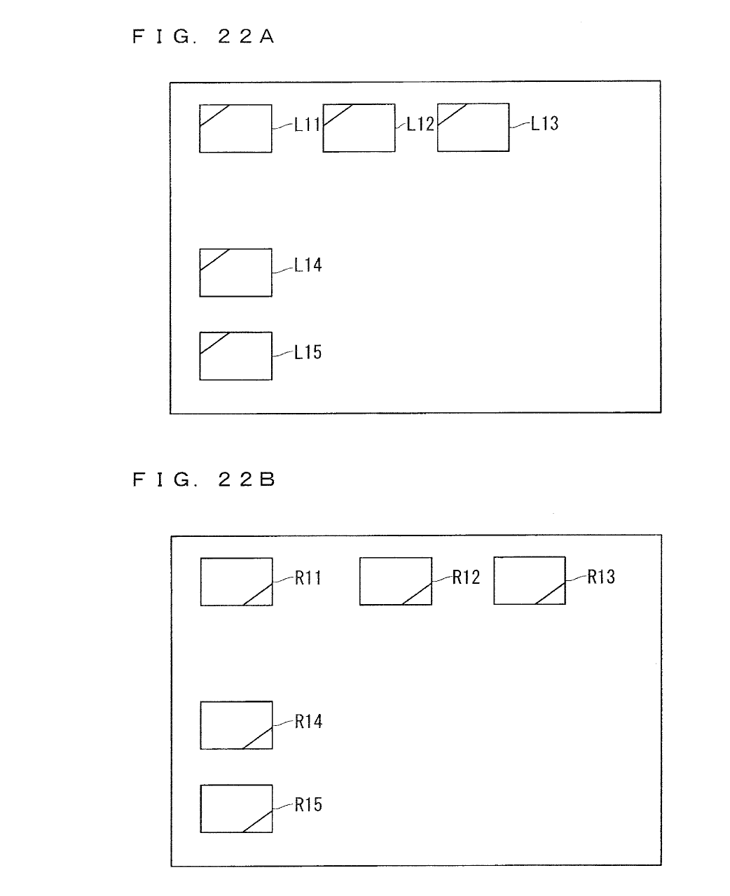

First, like in the first preferred embodiment, Steps S1 to S3 are executed. FIGS. 22A and 22B are views showing an example of display of the left image and the right image, respectively, in the navigation apparatus 1 (the split view display 2) in accordance with the second preferred embodiment in Step S3. As shown in FIGS. 22A and 22B, in Step S3, the controller 14 causes the split view display 2 to display thereon the normal left icons L11 to L15 (the second icons) and the normal right icons R11 to R15 (the fourth icons). Further, to the normal left icons L11 to L15, for example, applied are left icons which do not explicitly guide the first prescribed operation to be performed, and to the normal right icons R11 to R15, for example, applied are right icons which do not explicitly guide the second prescribed operation to be performed.

In Step S21 of FIG. 21, on the basis of the output signal from the touch panel 3, the operation input processor 9 determines whether or not the first prior action has been performed, in other words, whether or not the distance Z has become larger than zero and not larger than the first threshold value ZL. Further, on the basis of the output signal from the touch panel 3, the operation input processor 9 determines whether or not the second prior action has been performed, in other words, whether or not the distance Z has become larger than zero and not larger than the second threshold value ZR. As described above, since the first threshold value ZL is the same value as the second threshold value ZR herein, when the operation input processor 9 determines that the first prior action has been performed, the operation input processor 9 also determines that the second prior action has been performed.

When it is determined that the first prior action has been performed (the second prior action has been performed), the process goes to Step S22, and when it is not determined that the first prior action has been performed (the second prior action has been performed), Step S21 is performed again. Further, when Step S21 is performed again, if the map is displayed as the left image or the right image and the position of the self-vehicle has been changed, the controller 14 may scroll the map in accordance with the change of the position.

In Step S22, the controller 14 rotates the normal left icons L11 to L15 (the second icons) shown in FIG. 22A, to thereby transform the normal left icons into the left icons L1 to L5 (the first icons) shown in FIG. 8A which are capable of guiding the first prescribed operation to be performed. Similarly, the controller 14 rotates the normal right icons R11 to R15 (the fourth icons) shown in FIG. 22B, to thereby transform the normal right icons into the right icons R1 to R5 (the third icons) shown in FIG. 8B which are capable of guiding the second prescribed operation to be performed. Then, after Step S22, Steps S4 to S12 are performed like in the first preferred embodiment.

<Effects>

By the navigation apparatus 1 in accordance with the second preferred embodiment described above, when it is determined that the first prior action has been performed, the normal left icons L11 to L15 are transformed into the left icons L1 to L5 which are capable of guiding the first prescribed operation to be performed. Further, by the navigation apparatus 1 in accordance with the second preferred embodiment, when it is determined that the second prior action has been performed, the normal right icons R11 to R15 are transformed into the right icons R1 to R5 which are capable of guiding the second prescribed operation to be performed. With this operation, it is possible to provide the user with an impressive notification indicating that the first prescribed operation should be performed in order to perform the function of the left icon and the second prescribed operation should be performed in order to perform the function of the right icon.

If the first threshold value ZL>the second threshold value ZR, this indicates that the left icon on the driver's side is changed earlier. This case provides the driver's side with higher usability because the driver seat side can have longer time before performing the operation than the time that the front passenger seat side has and the driver has a little extra time.

### The First Variation of the Second Preferred Embodiment

In the second preferred embodiment, when it is determined that the first prior action has been performed, the controller 14 transforms the normal left icons L11 to L15 (in FIG. 22A) into the left icons L1 to L5 (in FIG. 8A) which are capable of guiding the first prescribed operation to be performed. This, however, is only one exemplary case, and for example, the controller 14 may add the first display objects such as the arrows 311 to 315 (in FIG. 12A), the points 331 to 335 (in FIG. 16A), or the like to the left icons L11 to L15, instead of transforming the normal left icons L11 to L15. Alternatively, the controller 14 may perform both transformation of the normal left icons L11 to L15 and addition of the first display objects.

Further, in the second preferred embodiment, when it is determined that the second prior action has been performed, the controller 14 transforms the normal right icons R11 to R15 (in FIG. 22B) into the right icons R1 to R5 (in FIG. 8B) which are capable of guiding the second prescribed operation to be performed. This, however, is only one exemplary case, and for example, the controller 14 may add the second display objects such as the arrows 321 to 325 (in FIG. 12B), the points 341 to 345 (in FIG. 16B), or the like to the right icons R11 to R15, instead of transforming the normal right icons R11 to R15. Alternatively, the controller 14 may perform both transformation of the normal right icons R11 to R15 and addition of the second display objects.

### The Second Variation of the Second Preferred Embodiment

In the second preferred embodiment, the controller 14 transforms the normal left icons L11 to L15 (in FIG. 22A) into the left icons L1 to L5 (in FIG. 8A) which are capable of guiding the first prescribed operation to be performed, only by rotating the normal left icons L11 to L15, and transforms the normal right icons R11 to R15 (in FIG. 22B) into the right icons R1 to R5 (in FIG. 8B) which are capable of guiding the second prescribed operation to be performed, only by rotating the normal right icons R11 to R15.

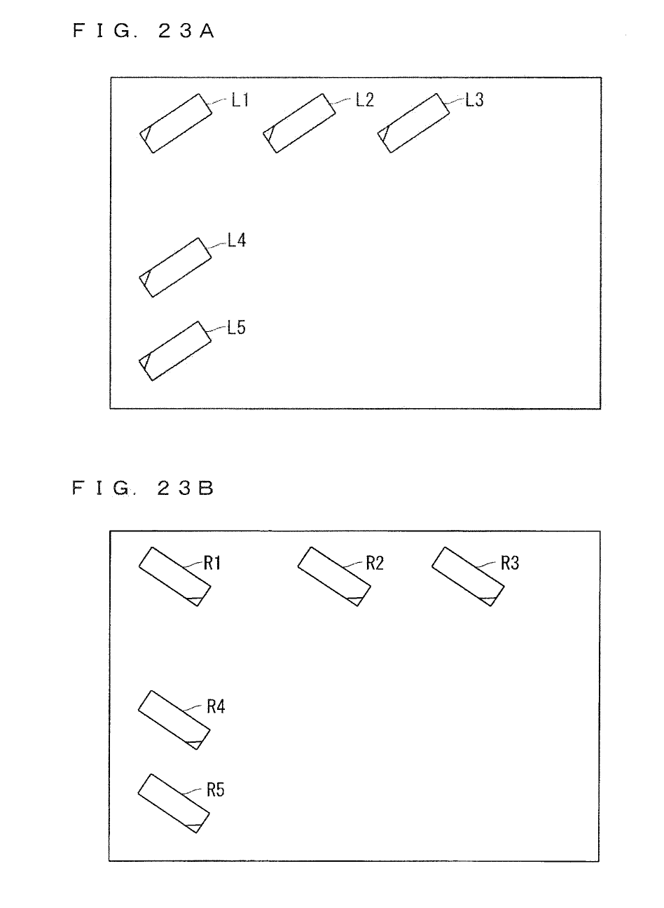

This, however, is only one exemplary case, and for example, the controller 14 may transform the normal left icons L11 to L15 (in FIG. 22A) into the left icons L1 to L5 shown in FIG. 23A which are capable of guiding the first prescribed operation (upward-right drag operation, herein) to be performed, by rotating the normal left icons L11 to L15 and changing the shape of each of the normal left icons L11 to L15 into an elongated slim shape. Similarly, the controller 14 may transform the normal right icons R11 to R15 (in FIG. 22B) into the right icons R1 to R5 shown in FIG. 23B which are capable of guiding the second prescribed operation (upward-left drag operation, herein) to be performed, by rotating the normal right icons R11 to R15 and changing the shape of each of the normal right icons R11 to R15 into an elongated slim shape.

### The Third Variation of the Second Preferred Embodiment

Though the first prior action is defined as an action in the case where the distance Z between the indicator and the touch panel 3 has become not larger than the first threshold value ZL in the second preferred embodiment, definition of the first prior action is not limited to the above.

The first prior action may be defined, for example, as an action in a case where a predetermined operation on the touch panel 3 by the indicator, other than the first prescribed operation, has been performed as the operation on the normal left icons L11 to L15 (in FIG. 22A). Specifically, in the configuration where the first prescribed operation is the upward-right drag operation and the operation determined as the first prior action is the one-point touch operation, it is assumed that the one-point touch operation is determined to have been performed as the operation on the normal left icon L11 shown in FIG. 22A. In this case, the controller 14 may change the left icon L11 shown in FIG. 22A into the left icon L1 shown in FIG. 8A.

Further, since the first prior action is the operation which is not the first prescribed operation (the operation other than the first prescribed operation), when it is determined that the first prior action has been performed on the left icon, this indicates that it is not determined that the first prescribed operation has been performed on the left icon. Therefore, in this case, the function associated with the left icon on which the first prior action has been performed is not performed and the left icon is transformed.

Furthermore, the second prior action may be defined in the same manner as the first prior action is defined above. Specifically, the second prior action may be defined as an action in a case where a predetermined operation on the touch panel 3 by the indicator, other than the second prescribed operation, has been performed as the operation on the normal right icons R11 to R15 (in FIG. 22B).

Further, the touch panel 3 and the operation input processor 9 may be configured to detect not only the above-described gesture operation (the touch operation and the orbital gesture operation) but also a push operation in which the degree of touching the icon is strong. Then, in this configuration, on the basis of the output signal from the touch panel 3, when the operation input processor 9 determines that the push operation on the left icon has been performed, it may be determined that the first prior action has been performed, and when the operation input processor 9 determines that the push operation on the right icon has been performed, it may be determined that the second prior action has been performed. Furthermore, in this configuration, the touch operation and the push operation may be replaced by each other. Specifically, when it is determined that the touch operation has been performed on the left icon, the controller 14 may determine that the first prior action has been performed, and when it is determined that the touch operation has been performed on the right icon, the controller 14 may determine that the second prior action has been performed.

Further, in the above configuration where the push operation can be also detected, when the distance Z has become larger than zero and not larger than the first threshold value ZL or the second threshold value ZR, the controller 14 may display the icon on which the push operation is needed to perform, in three dimensions. Furthermore, on the basis of the output signal from the touch panel 3, when the operation input processor 9 determines that a light touch operation has been performed on an icon, the operation input processor 9 may determine that the touch operation has been performed from the driver seat side, and when the operation input processor 9 determines that the push operation has been performed on an icon, the operation input processor 9 may determine that the push operation has been performed from the front passenger seat side. By adopting such a configuration, since the light touch operation is determined as the operation by the driver, it is possible to achieve an operation advantageous to the driver. Further, when decision is made on the light touch operation and the push operation, the touch operation may be made valid regardless of the type of the gesture operation.

Furthermore, the controller 14 may determine whether or not the prior action has been performed, discriminating between the first prior action and the second prior action, by considering not only the distance Z between the indicator and the detection surface but also the position (X, Y) of the indicator shown in FIG. 6. For example, when the operation input processor 9 determines that the position (X, Y, Z) of the indicator shown in FIG. 6 is located within a dome-like (hemispheric) spatial domain covering the left icon, the controller 14 may determine that the first prior action has been performed.

Further, when it is determined that the first prior action has been performed, the controller 14 in accordance with the second preferred embodiment rotates all the normal left icons L11 to L15 (in FIG. 22A), to thereby transform the normal left icons into the left icons L1 to L5 (in FIG. 8A) which are capable of guiding the first prescribed operation to be performed. This, however, is only one exemplary case, and when it is determined that the first prior action has been performed, the controller 14 may rotate at least one of the normal left icons L11 to L15 (for example, one left icon closest to the indicator), to thereby transform the normal left icon(s) into at least one of the left icons L1 to L5 which is capable of guiding the first prescribed operation to be performed. Similarly, when it is determined that the second prior action has been performed, the controller 14 may rotate at least one of the normal right icons R11 to R15 (for example, one right icon closest to the indicator), to thereby transform the normal right icon(s) into at least one of the right icons R1 to R5 which is capable of guiding the second prescribed operation to be performed. Furthermore, the controller 14 may be configured to not only transform any one icon but also transform the icon(s) located within a predetermined distance from the position of the indicator indicated by, for example, the coordinates (X, Y) or the like or located within a predetermined range including the position. The above operation may be also performed on the first and second display objects in the same manner, and may be also performed in the first preferred embodiment in the same manner.

### The Fourth Variation of the Second Preferred Embodiment

In the operation (see FIG. 21) described in the second preferred embodiment, when it is determined once that the first prior action has been performed, the controller 14 transforms the normal left icons L11 to L15 (in FIG. 22A) into the left icons L1 to L5 (in FIG. 8A) which are capable of guiding the first prescribed operation to be performed and then the state after the transformation is maintained.

This, however, is only one exemplary case, and there may be a case where the determination in Step S21 is performed again after it is determined that the first prior action has been performed and when it is determined that the first prior action is not being performed, the controller 14 may transform the left icons L1 to L5 (in FIG. 8A) back into the left icons L11 to L15 (in FIG. 22A).

Similarly, there may be another case where the determination in Step S21 is performed again after it is determined that the second prior action has been performed and when it is determined that the second prior action is not being performed, the controller 14 may transform the right icons R1 to R5 (in FIG. 8B) back into the right icons R11 to R15 (in FIG. 22B).

Further, when it is determined on the basis of the output signal from the touch panel 3 that the first prior action is being performed, the controller 14 may transform the normal left icon (the second icon) into the left icon (the first icon) which is capable of guiding the first prescribed operation to be performed. Herein, the action which is determined to be being performed may be an action continuing from the action which is determined to have been performed, or may be an action not continuing from the action which is determined to have been performed. As the latter action, i.e., the action not continuing from the action which is determined to have been performed, it is thought, for example, that the indicator is shaking under the situation where the distance Z is near the first threshold value ZL. In this case, in order to prevent the determination result from varying depending on the detection timing, the distance Z may be corrected by performing an LPF (Low Pass filter) signal processing. Similarly, when it is determined on the basis of the output signal from the touch panel 3 that the second prior action is being performed, the controller 14 may transform the normal right icon (the fourth icon) into the right icon (the third icon) which is capable of guiding the second prescribed operation to be performed. The above operation may be also performed on the first and second display objects in the same manner, and may be also performed in the first preferred embodiment or the third preferred embodiment in the same manner.

### Other Variations Related to the First and Second Preferred Embodiments

In the left image and the right image (shown in, for example, FIGS. 8A and 8B) described above, at least part of the display area of each of the left icons L1 to L5 and at least part of the display area of each of the right icons R1 to R5 overlap each other on the screen of the split view display 2. The arrangement of the icons is not limited to the above case only if at least part of the display area of at least one of the left icons L1 to L5 and at least part of the display area of at least one of the right icons R1 to R5 overlap each other on the screen of the split view display 2.

Further, when it is determined that an operation has been performed on the left icon and the right icon which are separated from each other on the screen of the split view display 2, the controller 14 may perform a function of the operated icon, regardless of the type of the operation which has been performed. Then, in this configuration, there may be a case where only the left icon whose display area overlaps that of the right icon on the screen of the split view display 2 is adopted as the left icon (the first icon) which is capable of guiding the first prescribed operation to be performed, or only the right icon whose display area overlaps that of the left icon on the screen of the split view display 2 is adopted as the right icon (the third icon) which is capable of guiding the second prescribed operation to be performed.

Though only the icons having one type of shapes constitute the icon arrangement image as shown in FIGS. 10A and 10B to 19A and 19B, for convenience of description, this is only one exemplary case and icons having a plurality of types of shapes may constitute an icon arrangement image by combining the various types of icons shown in FIGS. 10A and 10B to 19A and 19B. In particular, a group of icons having the same shape may be adopted for the icons used to perform similar functions, and another group of icons having the same shape of another type may be adopted for the icons used to perform other similar functions. For example, the same icon arrangement image may be constituted by adopting the icons shown in FIGS. 16A and 16B for a group of icons used for volume control and adopting the icons shown in FIGS. 13A and 13B for another group of icons used for navigation control.

In the above description, the case where the touch panel 3 is adopted as the input unit is taken as an example. The input unit, however, is not limited to the touch panel 3 only if the input unit can uniformly receive an operation on the left image for performing a function of an application and another operation on the right image for performing a function of another application. As the input unit, for example, a touch pad provided separately from the split view display 2 may be adopted. At that time, there may be a case where the touch pad has a function of obtaining a three-dimensional position of the indicator and the position of the indicator on an operation area of the touch pad is associated with the display area of the split view display 2, to thereby display a point or an icon indicating the position of the indicator.

### The Third Preferred Embodiment

The display control apparatus in accordance with the present invention may be applied to a display control apparatus which is configured as a system by combining, as appropriate, a PND (Portable Navigation Device), a so-called Display Audio which do not have any navigation function but has a display function, a portable terminal (for example, a cellular phone, a smartphone, a tablet, or the like), a server, and the like, which can be mounted on a vehicle, as well as the navigation apparatus 1 described in the first and the second preferred embodiments. In this case, the functions or the constituent elements of the navigation apparatus 1 described above are arranged dispersedly in these devices constituting the system.

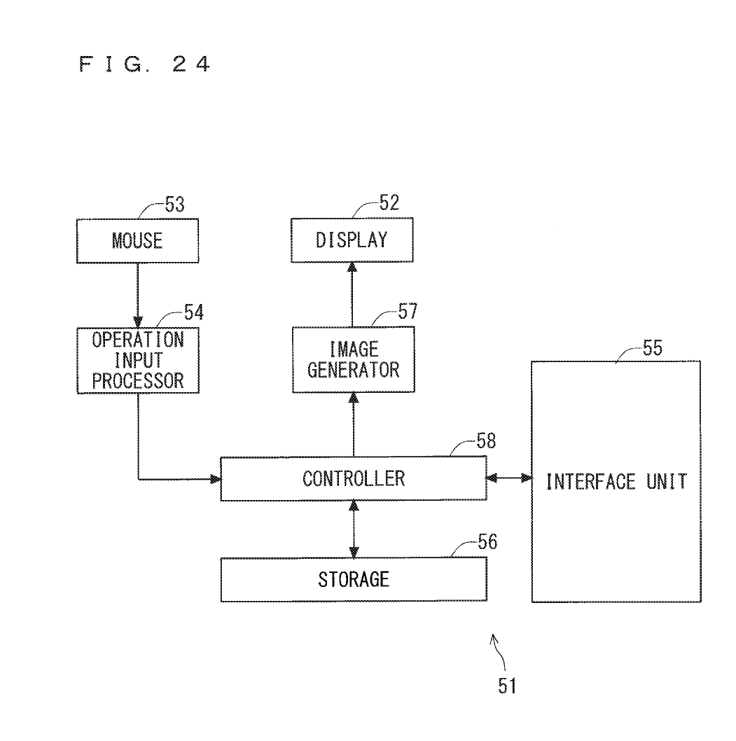

Further, the display control apparatus may be applied to any one of a PND, a portable terminal, a personal computer (hereinafter, referred to as a “PC”), and a server. In the third preferred embodiment of the present invention, description will be made on an exemplary case where the display control apparatus is applied to a PC 51. FIG. 24 is a block diagram showing an exemplary constitution of the PC 51. The PC 51 comprises a display 52, a mouse (input unit) 53, an operation input processor 54, an interface unit 55, a storage 56, an image generator 57, and a controller 58 which generally controls these constituent elements.

The display 52 is capable of displaying an image (first image). To the display 52, for example, applied is a display device which is capable of displaying the same image with respect to any given direction. Hereinafter, an icon in an image (the first icon in the first image) displayed on the display 52 is referred to as a “display icon”.

The mouse 53 receiving an external operation receives, from the user, a moving operation in which a cursor displayed in the image on the display 52 is moved and a button operation in which a button provided on the mouse 53 is pushed, and outputs a signal corresponding to the received operation to the operation input processor 54. Herein, description will be made on an exemplary case where the button operation includes a click operation, a double click operation, and the drag operation, but the button operation is not limited to this exemplary case.

The operation input processor 54 determines whether or not the moving operation in which the cursor is moved onto the display icon has been performed, on the basis of the output signal from the mouse 53. Further, the operation input processor 54 determines whether or not the button operation has been performed, on the basis of the output signal from the mouse 53.

In the third preferred embodiment, it is assumed that the first prescribed operation is the upward-right drag operation (operation drawing a predetermined orbit), like in the first preferred embodiment. As described above, since the operation input processor 54 is configured to determine whether or not the button operation has been performed, the operation input processor 54 can determine whether or not the first prescribed operation has been performed.

Further, the operation input processor 54 determines whether or not a first action which is defined in advance as an action before performing the first prescribed operation, i.e., the first prior action has been performed, on the basis of the output signal from the mouse 53. In the third preferred embodiment, it is assumed that the first prior action is defined as an action in a case where a predetermined operation other than the first prescribed operation has been performed as the operation on the display icon (the second icon). Hereinafter, as an example, it is assumed that the predetermined operation is the moving operation in which the cursor is moved onto the display icon. In other words, when the operation input processor 54 determines that the moving operation in which the cursor is moved onto the display icon has been performed, the operation input processor 54 determines that the first prior action has been performed, and otherwise the operation input processor 54 does not determine that the first prior action has been performed.

Further, when the operation input processor 54 determines that the button operation has been operated while the cursor is overlapping the display icon, the operation input processor 54 determines that the button operation has been performed on the display icon.

The operation input processor 54 outputs the above determination result to the controller 58. Further, though the operation input processor 54 is provided separately from the controller 58 in FIG. 24, the configuration is not limited to the above one but the operation input processor 54 may be included in the controller 58 as a function of the controller 58.

The interface unit 55 is connected between a not-shown communication unit or the like and the controller 58, and various information and various signals are bidirectionally outputted through the interface unit 55 between the communication unit or the like and the controller 58.

The storage 56 stores therein a program which the controller 58 needs in operation and information to be used by the controller 58. The information to be used by the controller 58 includes, for example, an application, an icon arrangement image, and the like.

The image generator 57 generates a display signal used to display an image on the basis of display information outputted from the controller 58 and outputs the display signal to the display 52. When the display 52 receives the display signal from the image generator 57, the display 52 displays the image on the basis of the display signal.

The controller 58 is, for example, a CPU, and the CPU executes the program stored in the storage 56, to thereby perform various applications in the PC 51.

Further, the controller 58 acquires, from the storage 56, one icon arrangement image corresponding to one or more applications which can be performed, and causes the display 52 to display thereon the acquired icon arrangement image as the image. With this operation, an icon to be operated for performing a function of the application(s) is displayed as the image on the display 52.

When the operation input processor 54 determines that the first prescribed operation (herein, the upward-right drag operation) has been performed, the controller 58 decides the first prescribed operation which is determined to have been performed, as the first operation (hereinafter, referred to as a “special operation”) for performing a function (hereinafter, referred to as a “special function”) of a predetermined application.

On the other hand, when the operation input processor 54 determines that the button operation other than the first prescribed operation has been performed, the controller 58 decides the button operation which is determined to have been performed, as an operation (hereinafter, referred to as a “normal operation”) for performing a function (hereinafter, referred to as a “normal function”) of a predetermined application other than the special function.

Further, when the operation input processor 54 determines that the first prior action has been performed, specifically, when the operation input processor 54 determines that the moving operation in which the cursor is moved onto the normal display icon (the second icon) has been performed, the controller 58 transforms the normal display icon into the display icon (the first icon) which is capable of guiding the first prescribed operation to be performed. In other words, when the operation input processor 54 determines that the first prior action has been performed, the controller 58 transforms the normal display icon and causes the display 52 to display the display icon (the first icon) in a form indicating a content of the first prescribed operation.

<Operation>

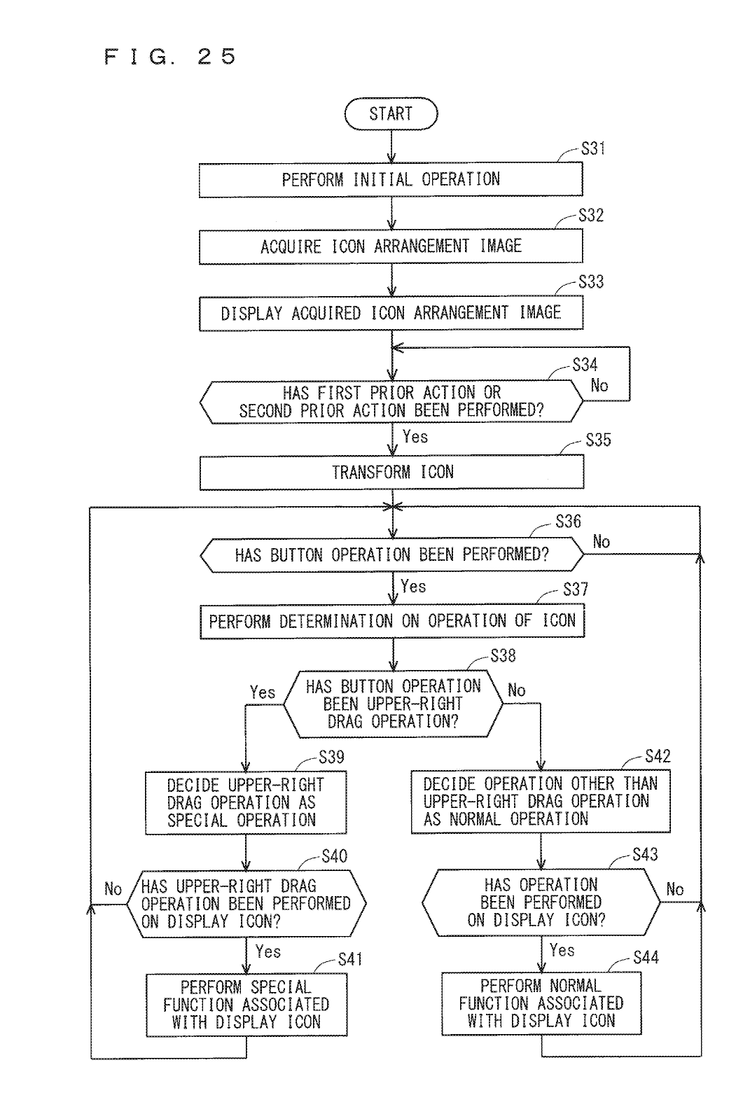

FIG. 25 is a flowchart showing an operation of the PC 51 in accordance with the third preferred embodiment. The operation shown in FIG. 25 is performed when the CPU executes the program stored in the storage 56. Hereinafter, with reference to FIG. 25, the operation of the PC 51 will be described.

In Step S31, first, when an operation used to perform an initial operation is performed, the controller 58 performs the initial operation. Herein, as the initial operation, the controller 58 acquires, from the storage 56, the applications to be performed initially and performs the applications.

In Step S32, from the storage 56, the controller 58 acquires the icon arrangement image corresponding to the application which is being performed.

In Step S33, the controller 58 displays the acquired icon arrangement image as the image of the display 52.

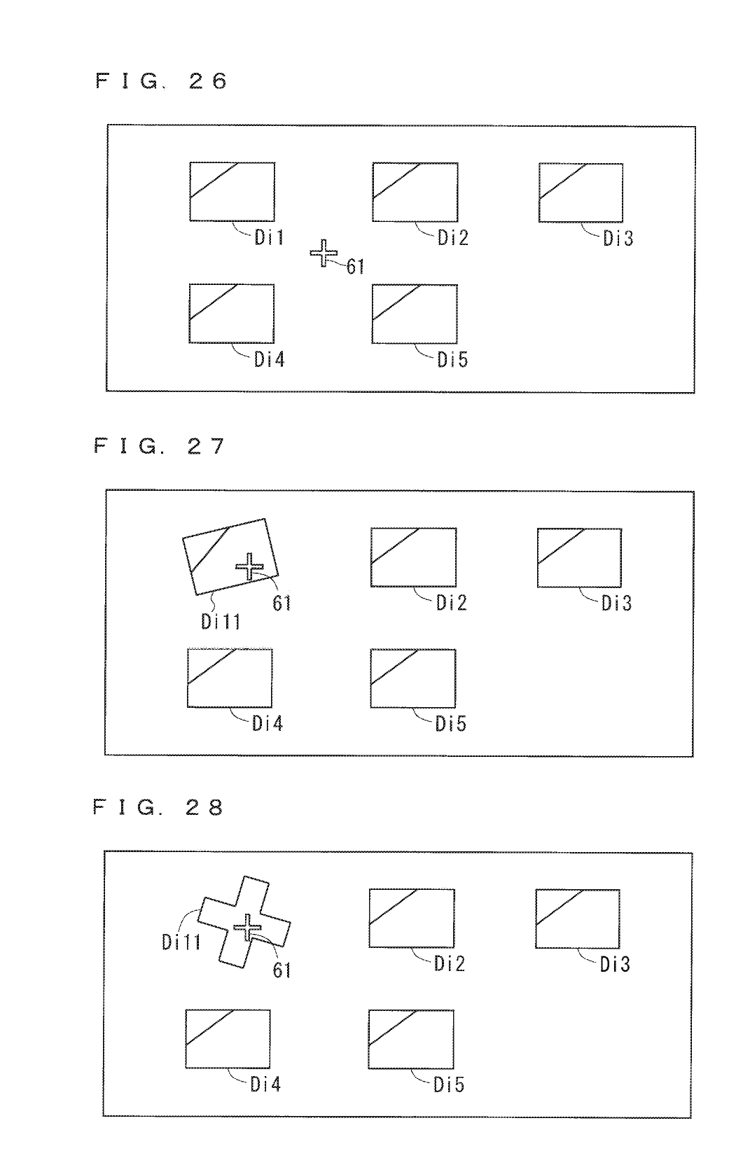

FIG. 26 is a view showing an example of display of the image in the PC 51 (the display 52) in accordance with the third preferred embodiment in Step S33. As shown in FIG. 26, in Step S33, the controller 58 causes the display 52 to display thereon normal display icons Di1, Di2, Di3, Di4, and Di5 (hereinafter, these icons are sometimes collectively referred to as “normal display icons Di1 to Di5”). Further, the controller 58 causes the display 52 to also display thereon a cursor 61 of the mouse 53.

In Step S34 of FIG. 25, on the basis of the output signal from the mouse 53, the operation input processor 54 determines whether or not the first prior action has been performed, in other words, whether or not the moving operation in which the cursor 61 is moved onto any one of the display icons Di1 to Di5 has been performed.

When it is determined that the first prior action has been performed, the process goes to Step S35, and when it is not determined that the first prior action has been performed, Step S34 is performed again. Further, though Step S35 and the following steps will be described below, assuming that it is determined that the moving operation in which the cursor 61 is moved onto the display icon Di1 shown in FIG. 26 has been performed, the same as described below applies to the case where it is determined that the moving operation in which the cursor is moved onto the display icon Di2, Di3, Di4, or Di5 has been performed.

In Step S35, the controller 58 rotates the normal display icon Di1 (the second icon) shown in FIG. 26, to thereby transform the normal display icon into a display icon Di11 (the first icon) shown in FIG. 27.

Herein, an outer frame shape of the display icon Di11 shown in FIG. 27 corresponds to the orbit of the upward-right drag operation which is the first prescribed operation. Specifically, the longitudinal direction of the display icon Di11 is aligned with the extension direction of a straight line to be drawn by the upward-right drag operation. The user can perform the upward-right drag operation, in other words, the first prescribed operation by using such an icon display as a clue. Thus, in Step S35, the controller 58 causes the display 52 to display thereon the display icon Di11 which is capable of guiding the first prescribed operation to be performed.

In Step S36 of FIG. 25, the operation input processor 54 determines whether or not the button operation has been performed. When it is determined that the button operation has been performed, the process goes to Step S37, and when it is not determined that the button operation has been performed, Step S36 is performed again. Further, since it can be assumed that the moving operation in which the cursor is moved onto the normal display icon Di2, Di3, Di4, or Di5 is performed, while Step S36 is repeatedly performed, the process may go back to Step S34 as appropriate.

In Step S37, the operation input processor 54 determines whether or not the button operation in Step S36 has been performed on the display icon Di11. Further, the determination result in this step will be used in Step S40 or S43.

In Step S38, the operation input processor 54 determines whether or not the button operation in Step S36 has been the upward-right drag operation. Further, it can be assumed that the button operation which is determined not to be the upward-right drag operation includes, for example, the click operation, the double click operation, and the like.

When it is determined that the button operation in Step S36 has been the upward-right drag operation, the process goes to Step S39, and when it is not determined that the button operation in Step S36 has been the upward-right drag operation, the process goes to Step S42.

When the process goes to Step S39 from Step S38, in Step S39, the controller 58 decides the button operation in Step S36, in other words, the upward-right drag operation as the special operation.

In Step S40, the controller 58 determines whether or not the upward-right drag operation which is decided as the special operation has been performed on the display icon Di11, on the basis of the decision result in Step S37. When it is determined that the upward-right drag operation has been performed on the display icon Di11, the process goes to Step S41, and otherwise the process goes back to Step S36.

In Step S41, the controller 58 performs the special function which is associated in advance with the display icon Di11 on which the upward-right drag operation has been performed. After that, the process goes back to Step S36. Further, when the icon arrangement image which is associated with the special function of the display icon Di11 in advance is stored in the storage 56, there may be a case where the process goes back from Step S41 to Step S33 and the icon arrangement image is displayed on the display 52.

When the process goes to Step S42 from Step S38, in Step S42, the controller 58 decides the button operation in Step S36 as the normal operation.

In Step S43, the controller 58 determines whether or not the button operation which is decided as the normal operation has been performed on the display icon Di11, on the basis of the determination result in Step S37. When it is determined that the button operation which is decided as the normal operation has been performed on the display icon Di11, the process goes to Step S44, and otherwise the process goes back to Step S36.

In Step S44, the controller 58 performs the normal function which is associated in advance with the display icon Di11 on which the button operation has been performed. After that, the process goes back to Step S36. Further, when the icon arrangement image which is associated with the normal function of the display icon Di11 in advance is stored in the storage 56, there may be a case where the process goes back from Step S44 to Step S33 and the icon arrangement image is displayed on the display 52.

<Effects>

By the PC 51 in accordance with the third preferred embodiment described above, when it is determined that the first prescribed operation (herein, the upward-right drag operation) has been performed, the first prescribed operation is decided as the special operation. Therefore, the user can selectively perform a desired one of the special function and the normal function.

Further, according to the third preferred embodiment, the display icon Di11 which is capable of guiding the first prescribed operation (herein, the upward-right drag operation) to be performed is displayed. Therefore, with the display as a clue, the user can know what the first prescribed operation is like before performing the operation.

Furthermore, according to the third preferred embodiment, when it is determined that the first prior action has been performed, the normal display icon Di1 is transformed into the display icon Di11 which is capable of guiding the first prescribed operation to be performed. With this operation, it is possible to provide the user with an impressive notification indicating that the first prescribed operation should be performed in order to perform the special function.

### Variation of the Third Preferred Embodiment

In the third preferred embodiment, when it is determined that the first prior action has been performed, the controller 58 transforms the normal display icon Di1 into the display icon Di11 which is capable of guiding the first prescribed operation to be performed (see FIGS. 26 and 27). This, however, is only one exemplary case, and the controller 58 may add the arrow 311 (the first display object) shown in FIG. 12A corresponding to the orbit of the upward-right drag operation to the display icon Di1, instead of transforming the normal display icon Di1. Alternatively, when it is determined that the first prior action has been performed, the controller 58 may perform both transformation of the display icon Di1 and addition of the arrow 311 (the first display object).

Further, when it is determined that the first prior action has been performed, the controller 58 in accordance with the third preferred embodiment rotates one normal display icon Di1 (in FIG. 26), to thereby transform the display icon into one display icon Di11 (in FIG. 27) which is capable of guiding the first prescribed operation to be performed. This, however, is only one exemplary case, and when it is determined that the first prior action has been performed, the controller 58 rotates at least one of the normal display icons Di1 to Di5, to thereby transform the display icon(s) into at least one of the display icons which is capable of guiding the first prescribed operation to be performed.

Furthermore, the controller 58 may display at least one of the display icon Di11 and the arrow 311 (the first display object) which are capable of guiding the first prescribed operation to be performed by animation (in a form of moving image), as shown in FIGS. 11A and 14A. By adopting this configuration, the user can know what the first prescribed operation is like more specifically.

Further, like in the first preferred embodiment, the controller 58 may cause the display 52 to display thereon at least one of the display icon Di11 and the arrow 311 (the first display object) which are capable of guiding the first prescribed operation to be performed, regardless of whether or not the first prior action has been performed.

Furthermore, a plurality of orbital operations may be adopted as the first prescribed operation. In an exemplary case of FIG. 28, for example, as the first prescribed operation, a first orbital operation drawing a first orbit (linear orbit extending in an upward-right direction in FIG. 28) and a second orbital operation drawing a second orbit (linear orbit extending in an upward-left direction in FIG. 28) are adopted. In such a configuration, the controller 58 may cause the display 52 to display thereon the display icon Di11 having a cross-like shape corresponding to the first orbit of the first orbital operation and the second orbit of the second orbital operation.

Instead of the mouse 53, a touch panel or a touch pad may be used. Then, the first prior action may be defined as an action in a case where the distance Z between the indicator such as a finger or the like and the touch panel or the touch pad has become not larger than the predetermined first threshold value. Further, when the first prescribed operation includes the first touch operation in which the indicator touches the touch panel or the touch pad with a predetermined first number of points, the controller 58 may display such a first display object as the number of points included in the first display object is equal to the first number of the first touch operation.

In the present invention, the preferred embodiments and the variations may be freely combined, or may be changed or omitted as appropriate, without departing from the scope of the invention.

While this invention has been shown and described in detail, the foregoing description is in all aspects illustrative and not restrictive. It is therefore understood that numerous modifications and variations can be devised without departing from the scope of this invention.

### DESCRIPTION OF REFERENCE NUMERALS

1 navigation apparatus, 2 split view display, 3 touch panel, 14, 58 controller, 21 finger, 51 PC, 52 display, 53 mouse, Di1 to Di5, Di11 display icon, L1 to L5, L11 to L15 left icon, R1 to R5, R11 to R15 right icon

1-17. (canceled)

18. A display control apparatus that controls a display which is capable of displaying thereon a first image, comprising:
a controller that decides a first prescribed operation which is determined to have been performed, as a first operation used to perform a function of a predetermined application, when it is determined that said first prescribed operation which is prescribed in advance has been performed, on the basis of an output signal from an input unit that receives an external operation,
wherein said controller causes said display to display thereon at least one of a first icon and a first display object in said first image, which is capable of guiding said first prescribed operation to be performed,
said controller performs at least one of transformation of a second icon in said first image into said first icon and addition of said first display object to said first image when it is determined that a first action which is defined in advance as an action before performing said first prescribed operation has been performed or is being performed, on the basis of an output signal from said input unit,
said first prescribed operation includes an operation drawing a predetermined orbit, which is performed on said first icon, and
at least one of an outer frame shape of said first icon and a shape of an arrow included in said first display object corresponds to said orbit.

19. A display control apparatus that controls a display which is capable of displaying thereon a first image, comprising:
a controller that decides a first prescribed operation which is determined to have been performed, as a first operation used to perform a function of a predetermined application, when it is determined that said first prescribed operation which is prescribed in advance has been performed, on the basis of an output signal from an input unit that receives an external operation,
wherein said controller causes said display to display thereon at least one of a first icon and a first display object in said first image, which is capable of guiding said first prescribed operation to be performed,
said controller performs at least one of transformation of a second icon in said first image into said first icon and addition of said first display object to said first image when it is determined that a first action which is defined in advance as an action before performing said first prescribed operation has been performed or is being performed, on the basis of an output signal from said input unit,
said first prescribed operation includes a first touch operation which is performed to touch said first icon with a predetermined first number of points, and
the number of points included in said first display object is equal to said first number of said first touch operation.

20. The display control apparatus according to claim 18, wherein
said first icon is displayed in a form indicating a content of said first prescribed operation.

21. The display control apparatus according to claim 18, wherein
said first action is defined as an action in a case where a predetermined operation other than said first prescribed operation has been performed as an operation on said second icon.

22. The display control apparatus according to claim 18, wherein
said first action is defined as an action in a case where a distance between an indicator and said input unit has become not larger than a predetermined first threshold value.

23. The display control apparatus according to claim 18, wherein
said controller displays at least one of said first icon and said first display object by animation.

24. The display control apparatus according to claim 18, wherein
said display is capable of displaying an image which is visible from a first direction but not visible from a second direction as said first image and also capable of displaying a second image which is visible from said second direction but not visible from said first direction on the same screen as said first image is displayed,
said first operation is an operation on said first image for performing a function of an application,
said input unit uniformly receives said first operation and a second operation on said second image for performing a function of another application, and
said controller decides said first prescribed operation or a gesture operation after said first prescribed operation, which is determined to have been performed, as said first operation, when it is determined that said first prescribed operation or said gesture operation has been performed, on the basis of an output signal from said input unit, and said controller decides a second prescribed operation which is different from said first prescribed operation and prescribed in advance or a gesture operation after said second prescribed operation, which is determined to have been performed, as said second operation, when it is determined that said second prescribed operation or said gesture operation has been performed, on the basis of an output signal from said input unit, and said controller causes said display to display thereon at least one of a third icon and a second display object in said second image, which is capable of guiding said second prescribed operation to be performed.

25. The display control apparatus according to claim 19, wherein
said display is capable of displaying an image which is visible from a first direction but not visible from a second direction as said first image and also capable of displaying a second image which is visible from said second direction but not visible from said first direction on the same screen as said first image is displayed,
said first operation is an operation on said first image for performing a function of an application,
said input unit uniformly receives said first operation and a second operation on said second image for performing a function of another application, and
said controller decides said first prescribed operation or a gesture operation after said first prescribed operation, which is determined to have been performed, as said first operation, when it is determined that said first prescribed operation or said gesture operation has been performed, on the basis of an output signal from said input unit, and said controller decides a second prescribed operation which is different from said first prescribed operation and prescribed in advance or a gesture operation after said second prescribed operation, which is determined to have been performed, as said second operation, when it is determined that said second prescribed operation or said gesture operation has been performed, on the basis of an output signal from said input unit, and said controller causes said display to display thereon at least one of a third icon and a second display object in said second image, which is capable of guiding said second prescribed operation to be performed.

26. The display control apparatus according to claim 24, wherein
said controller performs at least one of transformation of a second icon in said first image into said first icon and addition of said first display object to said first image when it is determined that a first action which is defined in advance as an action before performing said first prescribed operation has been performed or is being performed, on the basis of an output signal from said input unit, and
said controller performs at least one of transformation of a fourth icon in said second image into said third icon and addition of said second display object to said second image when it is determined that a second action which is defined in advance as an action before performing said second prescribed operation has been performed or is being performed, on the basis of an output signal from said input unit

27. The display control apparatus according to claim 26, wherein
said first action is defined as an action in a case where a distance between an indicator and said input unit has become not larger than a predetermined first threshold value or an action in a case where a predetermined operation other than said first prescribed operation, which is performed to said input unit by said indicator, has been performed as an operation on said second icon, and
said second action is defined as an action in a case where a distance between an indicator and said input unit has become not larger than a predetermined second threshold value or an action in a case where a predetermined operation other than said second prescribed operation, which is performed to said input unit by said indicator, has been performed as an operation on said fourth icon.

28. The display control apparatus according to claim 24, wherein
said first prescribed operation includes a first gesture operation drawing a predetermined first orbit, which is performed on said first icon, and
at least one of an outer frame shape of said first icon and a shape of an arrow included in said first display object corresponds to said first orbit of said first gesture operation.

29. The display control apparatus according to claim 28, wherein
said second prescribed operation includes a second gesture operation drawing a predetermined second orbit different from said first orbit, which is performed on said third icon, and
at least one of an outer frame shape of said third icon and a shape of an arrow included in said second display object corresponds to said second orbit of said second gesture operation.

30. The display control apparatus according to claim 25, wherein
said first prescribed operation includes a first touch operation which is performed to touch said first icon with a predetermined first number of points, and
the number of points included in said first display object is equal to said first number of said first touch operation.

31. The display control apparatus according to claim 30, wherein
said second prescribed operation includes a second touch operation which is performed to touch said third icon with a predetermined second number of points, the number of which is different from said first number, and
the number of points included in said second display object is equal to said second number of said second touch operation.

32. The display control apparatus according to claim 24, wherein
said controller displays at least one of said first icon, said first display object, said third icon, and said second display object by animation.

33. A display control method for controlling a display which is capable of displaying thereon a first image, comprising the steps of:
(a) deciding a first prescribed operation which is determined to have been performed, as a first operation used to perform a function of a predetermined application, when it is determined that said first prescribed operation which is prescribed in advance has been performed, on the basis of an output signal from an input unit that receives an external operation; and
(b) causing said display to display thereon at least one of a first icon and a first display object in said first image, which is capable of guiding said first prescribed operation to be performed, before said step (a),
wherein at least one of transformation of a second icon in said first image into said first icon and addition of said first display object to said first image is performed when it is determined that a first action which is defined in advance as an action before performing said first prescribed operation has been performed or is being performed, on the basis of an output signal from said input unit, in said step (b).
